(19) United States
(12) Patent Application Publication
(10) Pub. No.: US 2026/0217079 A1
(43) Pub. Date: Jul. 30, 2026

(54) HYDRAULIC ACTUATOR FOR A SPRING PRELOAD ADJUSTMENT SYSTEM FOR A SHOCK ABSORBER

(71) Applicant: ÖHLINS RACING AB, Upplands Väsby (SE)

(72) Inventors: Geir Lindblad, Märsta (SE); Frej Edberg, Upplands Väsby (SE); Peter Boon, Merchtem (BE); Stein Slootmaekers, Wellen (BE); Nils Göran Nygren, Huddinge (SE); Magnus Wallen, Märsta (SE)

(21) Appl. No.: 19/141,640

(22) PCT Filed: Dec. 22, 2023
(86) PCT No.: PCT/EP2023/087713

§ 371 Date: Jun. 20, 2025

(30) Foreign Application Priority Data
Dec. 22, 2022 (SE) 2251543-1

(51) Int. Cl. B60G 17/027

(52) U.S. Cl. CPC B60G 17/0272; B60G 2202/12; B60G 2202/413; B60G 2500/30

(57) ABSTRACT

The present disclosure relates to a hydraulic actuator for a spring preload adjustment system for a shock absorber. The hydraulic actuator comprising a fluid chamber, a piston slidably arranged within the fluid chamber in a first direction for moving hydraulic fluid out of the fluid chamber to increase spring preload of a shock absorber connected to the hydraulic actuator. The piston is further slidably arranged within the fluid chamber in a second, opposite, direction for allowing hydraulic fluid to enter the fluid chamber to decrease spring preload of the shock absorber. The hydraulic actuator further comprises a drive assembly operatively engageable with the piston, the drive assembly comprising a drive unit, a lead screw operatively connected to the drive unit, and a gear element engaged with the lead screw and arrangeable to abut the piston. The drive assembly is operable to actuate the piston to slide in the first direction and is operable to allow the piston to slide in the second direction without the drive unit being actuated.

### TECHNICAL FIELD

The present disclosure generally relates to the field of vehicle shock absorbers and particularly to a hydraulic actuator for a spring preload adjustment system for a shock absorber and a system for spring preload adjustment of a shock absorber.

### TECHNICAL BACKGROUND

Shock absorbers are widely used within vehicles and are designed to absorb and damp shock impulses and thereby improve ride quality and vehicle handling.

The distance the shock absorber is compressed under static loading of the spring is called sag. Rider sag, commonly referred to within the field of motorcycles, refers to the distance the shock absorber travels during static loading from the combined weight of the vehicle, single or multiple passengers, and potential luggage.

Besides being vital for the vehicle handling, the rider sag is crucial to set correctly in order to avoid the shock absorber bottoming or topping out. Bottoming out means that the shock absorber has been compressed to its maximum travel, causing it to abruptly stop which may cause severe damages. Topping out means that the shock absorber is fully extended and thereby incapable of following downward irregularities on the road, causing the vehicle to lose traction.

Many of today's shock absorbers are pre-loaded, which means that the spring part of the shock absorber is compressed when the shock absorber is fully extended. By providing adjustable pre-loading of the spring, the rider sag of the vehicle can be adjusted. Adjusting the pre-load of a spring is commonly done by, with the help of tools, rotating a spring platform or similar around a threaded portion of the shock absorber, causing the platform to slide axially along the rotation axis and thereby, by for example a nut, either compress or extend the spring.

As the spring preload is fundamental for setting the shock absorber function, using a hydraulic preload adjuster allows accurate preload adjustments without any need for tools. Hydraulic preload systems frequently comprise an external actuator system which by hydraulic force exchange enables the user to compress the spring and thereby adjusting the preload of the shock absorber.

However, the rising demand of modern vehicles being able to handle a large variety of load from passengers as well as luggage leads to an increased requirement of providing a high capacity for adjusting the rider sag.

Accordingly, there exists a need for a spring preload adjustment system for shock absorbers with improved capability of adjusting the height of a vehicle.

Further, hydraulic actuators in spring preload adjustment systems are used to control the spring preload of vehicle shock absorbers. Increasing the spring preload raises the ride height whereas decreasing the spring preload lowers the ride height. For motorcycles and similar vehicles, it is useful to have a low ride height when the vehicle is stationary so that a rider's feet can reach the ground, stabilizing the motorcycle and preventing it from falling over. When the vehicle is moving, the hydraulic actuator can increase the spring preload to raise the ride height for optimum driving conditions.

However, when the motorcycle is brought to a stop, it is essential to quickly lower the ride height so that the rider's feet can reach the ground to prevent the motorcycle from tipping over. This presents a challenge to the hydraulic actuators of today's spring preload adjustment systems, which are not capable of lowering the vehicle ride height at a sufficient rate, resulting in the motorcycle becoming unstable when brought to a stop.

Accordingly, there exists a need for a spring preload adjustment system for shock absorbers with improved capability of quickly adjusting the ride height of a vehicle.

### SUMMARY OF THE DISCLOSURE

At least some of the above-mentioned drawbacks are at least partly overcome by the present disclosure according to the independent claims. Preferred embodiments are set forth in the dependent claims.

It would be advantageous to improve the capacity of hydraulic actuator systems used for adjusting the preload of springs on shock absorbers.

To better address this concern, in accordance with a first aspect of the disclosure, there is provided a hydraulic actuator for a spring preload adjustment system for a shock absorber. The hydraulic actuator comprises a fluid chamber and a piston slidably arranged within the fluid chamber in a first direction for moving hydraulic fluid out of the fluid chamber to increase spring preload of a shock absorber connected to the hydraulic actuator. The piston is further slidably arranged within the fluid chamber in a second, opposite, direction for allowing hydraulic fluid to enter the fluid chamber to decrease spring preload of the shock absorber. The hydraulic actuator further comprises a drive assembly operatively engageable with the piston, the drive assembly comprising a drive unit, a lead screw operatively connected to the drive unit, and a gear element engaged with the lead screw and arrangeable to abut the piston. The drive assembly is operable to actuate the piston to slide in the first direction and is operable to allow the piston to slide in the second direction without the drive unit being actuated.

The disclosure is based on the insight that the hydraulic actuator provided, comprising a drive assembly operable to allow the piston to slide without the drive unit being actuated, allows the piston to slide within a fluid chamber of the hydraulic actuator without being restricted by the operational speed of the drive unit. Thereby, hydraulic fluid from a spring preload system can enter the fluid chamber without being restricted by the operational speed of the drive unit. This is advantageous in that it allows the hydraulic actuator to, in a short amount of time, receive a large amount of hydraulic fluid. When the hydraulic actuator is arranged in a spring preload adjustment system of a shock absorber of a vehicle, this allows for quickly decreasing the spring preload of the spring preload adjustment system and, thus, quickly lowering the ride height of the vehicle.

In addition, for most two-wheeled vehicles, the requirement of speed is higher when decreasing spring preload in comparison to when increasing spring preload. This because spring preload may be slowly increased while riding, but has to be quickly decreased when the vehicle is stopped, for example to enable a rider's feet to reach the ground to stabilize the vehicle and prevent it from falling over. As opposed to a hydraulic actuator where both the speed of increasing and decreasing spring preload is correlated with the operational speed of the drive unit, the hydraulic actuator as disclosed herein allows for quickly reducing preload independently from the operational speed of the drive unit. This is advantageous in that it allows the use of a drive unit with lower operational speed without reducing the actuators capacity of quickly decreasing preload.

By the phrase moving hydraulic fluid out of the fluid chamber to increase spring preload, it may be meant that hydraulic fluid is pushed out of the fluid chamber to a spring preload adjustment system for a shock absorber to which the hydraulic actuator is connected, and by hydraulic pressure increasing spring preload of the shock absorber.

By the phrase allowing hydraulic fluid to enter the fluid chamber to decrease spring preload of the shock absorber, it may be meant that hydraulic fluid, which is pressurized by the spring of the shock absorber in the spring preload adjustment system to which the hydraulic actuator is connected, is allowed to enter the fluid chamber. Thereby hydraulic pressure in the spring preload adjustment system is reduced, decreasing spring preload of the shock absorber.

By operational speed of the drive unit, it may be meant the speed of the motion it transmits, for example the speed with which it rotates the lead screw.

By the drive unit being actuated, it may be meant that the drive unit controls or manipulates its sub-components, wherein the sub-components are arranged to provide power transmission.

By spring preload adjustment system, it may be meant a system that utilizes fluid pressure to dynamically adjust the compression of a suspension spring. The system may comprise a hydraulic chamber and a hydraulic piston, and by varying the hydraulic pressure in the hydraulic chamber acting on the hydraulic piston, the hydraulic piston may move to adjust the preload of the suspension spring.

In accordance with an embodiment, the drive unit is arranged to provide power transmission via an axis thereof. The lead screw is operatively connected to the drive unit and extends therefrom along the axis, such that when the drive unit is operated, the lead screw is rotated around the axis, thereby transmitting power from the drive unit along the axis. The gear element is threadedly engaged with the lead screw such that rotation of the lead screw in a first rotational direction around the axis generates a linear motion of the gear element in the first direction and rotation of the lead screw in a second rotation direction around the axis generates a linear motion of the gear element in the second direction.

In accordance with an embodiment, the hydraulic actuator comprises a valve arrangement operable between a closed mode for preventing flow of hydraulic fluid into the fluid chamber and an open mode for allowing flow of hydraulic fluid into the fluid chamber.

Preventing flow of hydraulic fluid from entering the fluid chamber is advantageous for maintaining spring preload of a shock absorber when the hydraulic actuator is arranged in a spring preload adjustment system for the shock absorber. This because built-up hydraulic pressure in the preload adjustment system used to preloading the spring does not need to be maintained by the drive unit. This is beneficial for energy efficiency, as well as for reducing stress and wear on subcomponents of the drive assembly. Additionally, this may advantageously enable the drive assembly to, without being exposed to hydraulic pressure generated by the spring, mechanically adjust such to allow the piston to slide in the second direction without the drive unit being actuated.

Additionally, when the hydraulic actuator is arranged in a spring preload adjustment system for a shock absorber, operating the valve arrangement to the closed mode for preventing hydraulic fluid from entering the fluid chamber is advantageous for sealing hydraulic fluid in the preload adjustment system, thus ensuring that the desired spring preload is maintained.

In accordance with an embodiment, the gear element is movable in the second direction relative to the piston. That is, the gear element is not attached to the piston but may be moved in the second direction while the position of the piston remains unchanged. Particularly, when the valve arrangement is in the closed mode for preventing flow of hydraulic fluid into the fluid chamber, the gear element may move in the second direction relative the piston. Since hydraulic fluid is prevented from entering the fluid chamber, the constant amount of hydraulic fluid inside the fluid chamber prevents the piston from sliding in either the first or the second direction inside the fluid chamber. This is advantageous for enabling the drive unit to actuate the lead screw to rotate such to generate a translation of the gear element in the second direction away from the piston. The valve arrangement may thereafter be operated to the open mode to allow flow of hydraulic fluid to enter the fluid chamber. This will enable the piston to slide inside the fluid chamber, in the second direction, without the drive unit being actuated, until it abuts against the gear element. This is advantageous for enabling the hydraulic actuator to quickly receive hydraulic fluid to decrease preload of a spring preload adjustment system for a shock absorber when the hydraulic actuator is connected thereto.

In accordance with an embodiment, the valve arrangement comprises a solenoid valve. This is advantageous for using a single valve capable of being operable between a closed mode for preventing flow of hydraulic fluid into the fluid chamber and an open mode for allowing flow of hydraulic fluid into the fluid chamber. Additionally, using a solenoid valve is advantageous for its rapid and precise control over hydraulic fluid flow.

In accordance with an embodiment, the hydraulic actuator comprises a housing which houses the fluid chamber, the piston, and the drive assembly, wherein the valve arrangement is arranged external to the housing. The valve arrangement may thereby be arranged outside the housing. This may advantageously facilitate accessibility of the valve arrangement. This may be advantageous for mounting, controlling and/or replacing the valve arrangement.

In accordance with an embodiment, the hydraulic actuator comprises a housing which houses the fluid chamber, the piston, the drive assembly, the drive unit, and the valve arrangement. This is advantageous in that it provides a space efficient hydraulic actuator comprising a valve arrangement. This is further advantageous in that the housing provides a protective outer shell that is easy to package in a vehicle.

In accordance with an embodiment, the valve arrangement comprises a first valve for regulating a first fluid flow path for moving hydraulic fluid out of the fluid chamber to increase spring preload of the shock absorber. The valve arrangement further comprises a second valve for regulating a second fluid flow path for moving hydraulic fluid into the fluid chamber to decrease spring preload of the shock absorber. Providing a first fluid flow path and a second fluid flow path is advantageous for enabling automatic regulation of the flow rate of the hydraulic flow entering the fluid chamber and the hydraulic flow exiting the fluid chamber. The first fluid flow path may for example have a larger flow through cross sectional area than the second fluid flow path. Thereby, resistance of hydraulic fluid entering the fluid chamber is higher than the resistance of hydraulic fluid exiting the fluid chamber. This is advantageous for minimizing the required force from the drive unit to actuate the piston to slide in the first direction for moving hydraulic fluid out of the fluid chamber to increase spring preload of a shock absorber connected to the hydraulic actuator. Additionally, it is advantageous for increasing the resistance of hydraulic fluid entering the fluid chamber for avoiding too quick of a preload decrease. If the preload decrease is too quick, the ride height of the vehicle may drop uncomfortably fast, which may cause unnecessary force on the subcomponents of the hydraulic actuator or an uncontrollable motion for the rider of the vehicle.

In accordance with an embodiment, the first valve is a check valve. Having a check valve as a first valve is advantageous in that the check valve only allows flow in one direction. Thereby, the check valve may advantageously automatically regulate the first fluid flow path to be open when the piston slides in the first direction for moving hydraulic fluid out of the fluid chamber to increase spring preload of a shock absorber. Additionally, it may automatically regulate the first fluid flow path to be closed to prevent backflow entering the fluid chamber via the first fluid flow path. Using a check valve as the first valve is advantageous for removing the need of actively controlling the first valve.

In accordance with an embodiment, the second valve is controlled by the gear element. This is advantageous for enabling the drive unit, via the gear element to actively control the second valve and thereby the second fluid flow path, thus removing the need of a separate control system controlling the second valve.

In accordance with an embodiment, the second valve is a spool valve. This is advantageous for precisely controlling the flow rate through the second fluid flow path.

In accordance with an embodiment, the second valve comprises a valve body providing an inlet and an outlet. The second vale further comprises a valve member adapted to be movable relative to the valve body between a first position to fluidly disconnect the inlet and the outlet such that the second fluid flow path is closed, and a second position to fluidly connect the inlet and the outlet such that the second fluid flow path is open. The valve member is pretensioned into the first position. The gear element is arrangeable to engage the valve member when moved in the second direction to a predetermined point for moving the valve member from the first position to the second position as the gear element is further moved in the second direction. The valve member being movable relative the valve body between the first position and the second position by the gear element is advantageous for enabling that the regulation of the second valve may be controlled by the movement of the gear element. Thereby, the drive unit may control the second valve which is advantageous since it removes the requirement of an additional control system controlling the valve arrangement.

In one accordance with one embodiment, the valve arrangement comprises a valve body, a valve member adapted to be movable relative to the valve body between a first position to control the valve arrangement to be in the closed mode and a second position to control the valve arrangement to be in the open mode, wherein the gear element is arrangeable to engage the valve member when moved in the second direction to a predetermined point for moving the valve member from the first position to the second position as the gear element is further moved in the second direction.

The valve member may advantageously control the valve arrangement. Thereby, a single valve such as a check valve may be used to allow hydraulic fluid to exit the fluid chamber and preventing backflow, while also being controlled by the valve member to allow hydraulic fluid to enter the fluid chamber. A check valve may thereby advantageously be used for regulating hydraulic fluid flow through the valve arrangement.

Additionally, the drive unit may control the movement of the valve member between the first position and the second position via the gear member. This is advantageous since the need for an additional control device controlling the valve arrangement is removed.

In accordance with an embodiment, the valve member is pretensioned into the first position by hydraulic pressure. It is advantageous to use hydraulic pressure to pretension the valve member into the first position since no added tension mechanism is required. The hydraulic fluid pressure in the second fluid flow path is advantageously used to pretention the valve member into the first position.

In accordance with an embodiment, wherein the drive unit has a longitudinal extension along the axis and the fluid chamber has a longitudinal extension along or in parallel with the axis, the longitudinal extension of the fluid chamber is at least partly overlapping with the longitudinal extension of the drive unit.

The hydraulic actuator provided, comprising a drive unit and a fluid chamber which extends at least partly in parallel with the drive unit, may increase the force output while maintaining or reducing the length of the hydraulic actuator. This is advantageous since the hydraulic actuator can be shorter, while maintaining force output, and is thereby easier to package within a vehicle.

According to a second aspect of the disclosure, there is provided a system comprising a hydraulic actuator as disclose herein, a preload adjuster comprising an adjuster piston, and a connector defining a fluid flow connection between the hydraulic actuator and the preload adjuster. The adjuster piston is operable by the hydraulic actuator to move in an axial direction of a shock absorber cylinder onto which it is mounted, and arrangeable to act on a spring of the shock absorber such to affect the preload of the same.

According to a third aspect of the disclosure, there is provided a method for adjusting preload of a spring of a shock absorber. The method comprises providing a hydraulic actuator as disclosed herein, operatively disengaging the drive unit from the piston, allowing hydraulic fluid into the fluid chamber such that the piston slides in the second direction for rapidly reducing preload of the shock absorber without the drive unit being actuated. The method may further comprise actuating the piston in the first direction for increasing preload of the shock absorber.

According to an embodiment, the step of operatively disengaging the drive unit may further comprise preventing flow of hydraulic fluid into the fluid chamber, moving the gear element relative to the piston in the second direction, and allowing flow of hydraulic fluid to enter the fluid chamber.

According to an embodiment, the step of moving the gear element may further comprise moving the gear element relative to the piston in the second direction into engagement with a valve member of the hydraulic actuator; and moving the gear element relative to the piston in the second direction for moving the valve member into the second position for allowing flow of hydraulic fluid to enter the fluid chamber.

It would be advantageous to improve the capacity of hydraulic actuator systems used for adjusting the preload of springs on shock absorbers.

To better address this concern, in accordance with a fourth aspect of the disclosure, there is provided a hydraulic actuator for a spring preload adjustment system for a shock absorber, the hydraulic actuator comprising a drive unit arranged to provide power transmission via an axis of the drive unit. The hydraulic actuator comprises one or more fluid chambers, each comprising an aperture at a first end thereof; and one or more actuator pistons, each slidable within a respective fluid chamber in a second direction thereof for moving hydraulic fluid into the fluid chamber via the aperture and in a first direction for moving hydraulic fluid out of the fluid chamber via the aperture. The one or more actuator pistons is operatively connected to the drive unit such that the power transmission provided by the drive unit generates a translation of the actuator piston in a direction of the axis; and each of the one or more fluid chambers extends at least partly in parallel with the drive unit. The disclosure is based on the insight that the hydraulic actuator provided, comprising a drive unit and a fluid chamber which extends at least partly in parallel with the drive unit, may increase the force output while maintaining or reducing the length of the hydraulic actuator. As opposed to a hydraulic actuator where a fluid chamber, an actuator piston arranged to act within the fluid chamber, and a drive unit, are aligned along an axis, the length of a hydraulic actuator as disclosed herein does not have to include the total length of all said three components. Due to the fluid chamber extending at least partly in parallel with the drive unit, the length of the hydraulic actuator must only exceed the longest of the combined length of the fluid chamber together with the actuator piston, and the length of the drive unit. This allows minimizing the length of the hydraulic actuator with respect to the length of its fluid chamber together with its actuator piston. This is advantageous since the hydraulic actuator can be shorter, while maintaining force output, and is thereby easier to package within a vehicle.

Thus, the hydraulic actuator as disclosed herein may, with respect to a hydraulic actuator known in the art, where a fluid chamber, an actuator piston and a drive unit are aligned along an axis, be shortened while maintaining the length of its fluid chamber. Alternatively, the hydraulic actuator may maintain its length while extending the length of its fluid chamber. By increasing the length of the fluid chamber, a stroke length of the actuator piston, arranged to act inside the fluid chamber, is increased. The increase of stroke length further extends the distance that the actuator piston may displace a hydraulic fluid through an aperture in the fluid chamber.

This is advantageous since by increasing the distance that the hydraulic fluid may be displaced, the hydraulic force ratio between the power input in the hydraulic actuator and the power output acting on a spring of a shock absorber is, via hydraulic force exchange, increased. This increased hydraulic ratio enables the actuator system to apply more force preloading the spring and thereby increases the range within which the spring may be preloaded. This is advantageous since an increase of range of preloading (preload spring travel), leads to an improved capacity of the vehicle to preload a shock absorber to fulfil the requirements of different riders which put different loads on the vehicle. Increased ability to adjust the preload spring travel is also advantageous to improve the handling of the vehicle while driving.

In addition, by increasing the length of the fluid chamber, the stroke length of the one or more actuator pistons may be extended. This is advantageous since more hydraulic fluid may be displaced, thus more energy may be transferred from the hydraulic actuator to the spring. Further, the hydraulic actuator may be arranged such that the hydraulic fluid is displaced within a closed system reaching between the hydraulic actuator and an adjuster piston acting on a spring of a shock absorber. The position of the actuator piston will then indicate the level of preload acting on the spring. This is advantageous because the system is capable of tracking the preload of the spring and, if needed, adjusting it to an optimal level. As of these reasons, the hydraulic actuator may advantageously be used in combination with a shock absorber on a vehicle in order to adapt the preload of the spring to better fit to what is desired based on the current situation. Additional further developments will be apparent from the following aspects and embodiments of the disclosure, as well as from the appended claims.

In accordance with an embodiment, the drive unit has a longitudinal extension along the axis, and each of the one or more fluid chambers has a longitudinal extension parallel to the longitudinal extension of the drive unit, wherein the longitudinal extension of each of the one or more fluid chambers at least partly overlaps with the longitudinal extension of the drive unit. This provides a compact hydraulic actuator, which is advantageous.

In accordance with an embodiment, the drive unit is arrangeable to provide power transmission via the axis in a rotational direction thereof, wherein the power transmission in the rotational direction generates a translation of the actuator piston in parallel with the axis. This is advantageous for providing an efficient power transmission of the hydraulic actuator.

In accordance with an embodiment, the drive unit comprises an electric motor. This may for example be a brushless DC electric motor. Using an electric motor is advantageous since they have a high power-to-weight ratio, high speed, nearly instantaneous control of speed (rpm) and torque, high efficiency, and low maintenance. Further, using an electric motor is particularly beneficial if used in combination with electric sensors for providing fast and accurate adjustments.

In accordance with an embodiment, the hydraulic actuator further comprises a lead screw operatively connected to the drive unit. Said lead screw extends therefrom along the axis, such that when the drive unit is operated the lead screw is rotated, thereby transmitting power from the drive unit along the axis. This is advantageous since it enables an efficient power transmission from the drive unit to the actuator piston. The lead screw enables power to be transmitted, from a rotational direction around the axis into a translational direction along the axis. Using the lead screw for transmitting power is also advantageous since it transmits power by rotational movement, without any translational movement. Thereby occupying a minimal amount of space. It will further be appreciated that the threads of the lead screw may be obtained by means of a thread rolling manufacturing process. That is, the threads of the lead screw may be produced by compression between rotating or reciprocating dies, wherein a thread profile is ground into the dies. The thread rolling manufacturing process provides a smooth surface finish to the threads of the lead screw, resulting in a reduction of friction with the corresponding threads in contact therewith. This in turn leads to the reduction of wear and therefore the prolongation of the service life of the lead screw, which is advantageous.

In accordance with an embodiment, the hydraulic actuator further comprises a gear element in threaded connection with the lead screw. Wherein the gear element is engaged with the one or more actuator pistons, such that rotation of the lead screw generates a linear motion of the gear element and thereby the translation of the one or more actuator pistons. This is advantageous since it enables the rotational movement of the lead screw to be converted into a linear motion, causing the one or mor actuator pistons to be translated linearly in parallel with the axis. The gear element is preferably balanced such that, by rotation of the lead screw, it only moves in a translational direction, thereby not causing any pivoting forces to act on the one or more actuator pistons. In an embodiment wherein the hydraulic actuator comprises a plurality of actuator pistons, the plurality of actuator pistons may advantageously be positioned on the gear element such to provide balance. The linear motion of the gear element, generated from the rotational motion of the lead screw, will thereby be equally transferred to each actuator piston promoting a smooth homogenous motion.

In accordance with an embodiment, the lead screw extends from the drive unit in the second direction of the axis. The lead screw further comprises a first lead screw end operatively connected to the drive unit and a second, opposite lead screw end. The gear element is arranged to move linearly towards the first lead screw end when the drive unit is actuated to move the one or more actuator pistons in the first direction for moving hydraulic fluid out of the one or more fluid chambers, and to move linearly towards the second lead screw end when the drive unit is actuated to move the one or more actuator pistons in the second direction for moving hydraulic fluid into the one or more fluid chambers. This provides for a simple structure that has the advantage of being space efficient while also comprising a low number of parts.

In accordance with an embodiment, the hydraulic actuator comprises one or more actuator pistons, wherein the one or more actuator pistons are arranged such to create balance in the gear element during the power transmission. Since the one or more actuator pistons is/are positioned on the gear element such to provide balance, the gear element will not be exposed to torque causing it to tilt relative the lead screw. The process of converting rotational motion in the lead screw to a linear motion of the gear element may thereby advantageously proceed without risk of rotational displacement against the axis or tilting of the gear element causing undesired friction or harm to the hydraulic actuator. In view of this disclosure, the skilled person understands that a hydraulic actuator may be provided comprising, e.g., 1, 2, 4, or 6 actuator pistons within the concept of the present disclosure. Providing more than one actuator piston is advantageous for distributing the force in the gear element so as to not cause damages due to stress overload. Alternatively, one actuator piston may be provided which is concentric around the lead screw, to evenly distribute the force in the gear element.

In accordance with an embodiment, the hydraulic actuator comprises a housing for housing the drive unit, the one or more fluid chambers and the one or more actuator pistons, and a first and a second end cap. The housing provides for several advantages, for example protection of dirt or damages towards the components of the hydraulic actuator, and the ability to facilitate mounting of the hydraulic actuator on a vehicle. In addition, providing the housing and the first and second end caps is advantageous because it allows for an efficient assembly of the hydraulic actuator.

According to an aspect, there is provided a method of assembling the hydraulic actuator as disclosed herein. The assembly process comprises the steps of fastening the lead screw and the gear element, e.g. a lead screw nut, to the second end cap by a fastener, such as a screw, to provide a lead screw subassembly. The method further comprises the step of inserting the drive unit in the housing from a first housing end, in a direction towards a second housing end, which is opposite the first housing end, whereby the drive unit is geometrically locked within the housing. The method further comprises inserting the lead screw subassembly into the housing from the second housing end and thereby connecting the lead screw to the drive unit. The housing is generally shaped such to form a substantially central longitudinal cavity arranged to receive the drive unit and with one or more longitudinal through-holes, each of which defines a fluid chamber. The method further comprises the step of inserting the one or more actuator pistons in the housing from the first housing end. Each of the one or more actuator pistons is inserted through its respective fluid chamber and pressed towards the gear element until engagement therewith. The method further comprises filling the one or more fluid chambers with hydraulic fluid. The method further comprises the step of fastening, by a fastener, the first end cap to the housing at the first housing end, thereby providing the hydraulic actuator. The fastener may for example be one or more screws, pins, rivets, or nails. This allows for efficient assembling of the hydraulic actuator. By using a fastener that is releasable, such as e.g. a screw, disassembly of the hydraulic actuator is further facilitated. It is, however, also possible within the concept of the present disclosure, to provide a fastener which is not releasable, such as e.g. an adhesive, for the assembly of the hydraulic actuator. The method optionally further comprises providing a rubber cover over a cavity on the second end cap to cover a lead screw bearing.

In accordance with an embodiment, the first end cap comprises a compartment in connection with the aperture of each of the one or more fluid chambers, and wherein the end cap comprises a channel extending from the compartment through a wall portion of the end cap to an exterior surface thereof. The compartment connected with each of the apertures of the one or more fluid chambers is advantageous since it enables the hydraulic fluid, when displaced by at least one actuator piston, to move along a channel while equalizing the pressure to be homogenous.

In accordance with one embodiment, the first end cap comprises two compartments, each in connection with an aperture of a chamber without the compartments being interconnected, and wherein each compartment is in connection with a channel extending through a wall portion of the end cap to an exterior surface thereof. This is advantageous because each of the independent compartments may be coupled to different hydraulic circuits of a vehicle. The one or more actuator pistons coupled to respective hydraulic circuits is advantageously arranged such to create balance in the gear element during power transmission. If, for example, a single actuator piston is coupled to each hydraulic circuit through the respective compartment, each of the single actuator pistons is preferably concentric around the lead screw. Alternatively, if a plurality of actuator pistons, such as for example two actuator pistons, is coupled to each hydraulic circuit via a compartment, they are preferably diametrically opposed around the lead screw. Thereby, unequal fluid pressure in compartments connected to different hydraulics circuits will not cause imbalance in the gear element. One hydraulic actuator can thereby, by hydraulic force, for example control the spring preload of multiple shock absorbers on a vehicle. Providing compartments that are not interconnected is further advantageous since it enables hydraulic fluid of several hydraulic circuits to be independent, and the pressure of the hydraulic fluid may therefore not have to be equalized between the hydraulic circuits. This is advantageous since it enables the hydraulic actuator, by one linear motion of multiple actuator pistons, to control multiple hydraulic circuits which may be coupled to different systems of a vehicle. Different systems on a vehicle may for example be a first system coupled to one or more front wheel shock absorbers and a second system coupled to one or more rear wheel shock absorbers.

In accordance with one embodiment, the first end cap houses electric components for the electric motor. This is advantageous since the components may share the protection provided by the housing of the hydraulic actuator. Further, it is beneficial during assembly of the hydraulic actuator on the vehicle. A further advantage is that by providing electric components in the end cap, i.e. close to the electric motor, potential disturbance caused by external devices may be reduced leading to better functioning of the drive unit.

In accordance with one embodiment, the hydraulic actuator comprises a pressure sensor configured to sense a pressure within the fluid chamber. This is advantageous since the pressure sensor may, by evaluating the pressure in the fluid chamber, determine the force output from the hydraulic actuator. Further, the sensor may be coupled to a control system for automatically controlling the drive unit to adjust the one or more actuator pistons. This is advantageous, for example, when the hydraulic actuator is coupled to an adjuster piston for adjusting spring preload of a shock absorber, because the spring preload may automatically be adjusted from the output of the sensor. Providing a pressure sensor is further advantageous since it may be used for sensing pressure overload, which can be used for actuating a movement of the actuator piston to avoid damage of the hydraulic actuator or any related component or component connected therewith. Alternatively, a position sensor, such as a potentiometer may be used to determine the force output from the hydraulic actuator, thus enabling the system to automatically control the hydraulic actuator.

In accordance with a fifth aspect of the present disclosure, there is provided a method for actuating a hydraulic actuator for a spring preload adjustment system of a shock absorber. The method comprises providing a hydraulic actuator as disclosed herein. The method further comprises actuating the drive unit of the hydraulic actuator to provide power transmission via an axis of the drive unit in a first rotational direction thereof, wherein the power transmission in the first rotational direction generates a translation of the one or more actuator pistons of the hydraulic actuator in a direction parallel with the axis, in a second direction of the one or more fluid chambers of the hydraulic actuator for moving hydraulic fluid into the one or more fluid chambers, and/or actuating the drive unit to provide power transmission via the axis in a second rotational direction thereof, generating thereby a translation of the one or more actuator pistons in a first direction of the one or more fluid chambers for moving hydraulic fluid out of the fluid chamber. This provides for an efficient method for actuating a hydraulic actuator. The hydraulic actuator may, by actuating a rotational motion of the drive unit, quickly generate a linear translational motion of the actuator piston, and thereby displace the hydraulic fluid of the fluid chamber. Thereby the method provides for a fast response system, e.g. for adjusting the preload of a spring of a shock absorber when the hydraulic actuator is connected thereto, which is advantageous. Further, in an embodiment in which the hydraulic actuator is coupled to a shock absorber wherein the hydraulic fluid moves in a sealed system between the hydraulic actuator and the shock absorber, the position of the actuator piston traces the amount of hydraulic fluid used for preloading the shock absorber. This is advantageous since it allows for continuous tracking of the preload. This may be used for further optimising the performance or timing of the shock absorber.

In accordance with a sixth aspect of the present disclosure, there is provided a system for spring preload adjustment of a shock absorber comprising a hydraulic actuator as disclosed herein, a preload adjuster comprising an adjuster piston, and a connector arranged to provide a fluid connection between the hydraulic actuator and the preload adjuster. The adjuster piston is operable by the hydraulic actuator to move in an axial direction of a shock absorber cylinder onto which it is mounted, and arrangeable to act on a spring of the shock absorber such to affect the preload of the same.

Providing a preload adjuster that is in fluid connection with the hydraulic actuator is advantageous because the structure of the preload adjuster may be optimized with respect to the structure of the hydraulic actuator.

Since the hydraulic ratio is derived from the difference in cross-sectional area between the actuator piston and the adjuster piston, a manufacturer may modify said areas for adjusting the force output generated by the hydraulic ratio. This is advantageous since it allows a manufacturer to, for example, reduce the cross-sectional area of the actuator piston, thereby increasing the hydraulic ratio and reducing the required force output from the drive unit to actuate the actuator. If the cross-sectional area of the actuator is reduced to increase the hydraulic ratio, the stroke length of the actuator pistons may be extended to compensate for the reduction of work. Alternatively, the cross-sectional area of the actuator piston may be increased in order to achieve the opposite effect which may be advantageous if, for example, the drive unit is working below its capacity.

In accordance with a further embodiment, the system comprises a computer programmed to command the hydraulic actuator to move the actuator piston in the second direction to decrease hydraulic pressure in the preload adjuster such to decrease preload of a spring when the adjuster piston is arranged to act thereon, and to command the actuator to move the actuator piston in the first direction to increase hydraulic pressure in the preload adjuster such to increase preload of the spring when the adjuster piston is arranged to act thereon. This allows adjusting the hydraulic actuator based on/according to a variety of parameters such as, e.g., driving comfort, vehicle handling, energy efficient driving or facilitate entering, facilitating riders entering or exiting a motorcycle or stabilization.

In accordance with a further embodiment, the system further comprises a cylinder head for a shock absorber, wherein the cylinder head at least partly houses the preload adjuster. This is advantageous since the preload adjuster may be integrated in the cylinder head. As opposed to a system where the preload adjuster is independently placed on a shock absorber, the disclosed cylinder head is housing the preload adjuster, reducing the needed number of parts. This is advantageous since the reduction of parts saves costs and facilitates assembly, for example. This is further advantageous as it makes the system easier to assemble.

In accordance with a further embodiment, the preload adjuster further comprises a spring guide arrangeable around an exterior circumferential surface of a shock absorber cylinder. The spring guide extends, in the axial direction of the shock absorber cylinder, from an adjuster piston abutting portion of the spring guide, arranged to abut an end of the adjuster piston, to a spring abutting portion of the spring guide, arranged to abut an end of a spring of the shock absorber onto which the system is mounted, wherein the spring guide is axially displaceable. The spring guide is advantageous since the adjuster piston thereby does not have to be in direct contact with the spring. This is beneficial since the adjuster piston does not have to be exposed to bending forces generated by the spring when displaced. The spring guide can easily be replaced if worn down. Further, the spring, when displaced as a part of preloading, may generate forces that are not aligned with the axial direction of the shock absorber cylinder. By providing a spring guide, it may absorb the forces that are not aligned with the axial direction of the shock absorber cylinder and act as a medium only transmitting forces in the axial direction between the adjuster piston and the spring. This will ensure that only axial forces are transmitted to the adjuster piston which is advantageous since it reduces the wear of the adjuster piston. The spring guide is preferably made of a polymer. This is advantageous for creating low friction surfaces, reducing cost of manufacturing, and improving shape ability.

In accordance with a further embodiment, the spring guide further comprises a stabilizer portion, which stabilizer portion projects from the spring abutting portion at an inner radial end portion thereof in a direction away from the adjuster piston abutting portion. The stabilizer portion further comprises a lip portion, which lip portion circumferentially abuts the shock absorber cylinder and extends circumferentially at an end of the stabilizing portion which is opposite the spring abutting portion. The extension of the stabilizer portion is advantageous since it increases the stability of the spring guide and improves its capacity to withstand bending forces or bending torque. This further protects the adjuster piston from exposure to radial forces, which is advantageous. Further, the stabilizer portion limits the amplitude of transversal oscillations of the spring, which is advantageous. Even further, when the preload adjuster is mounted on a shock absorber, the lip element advantageously seals the space between the spring guide and the shock absorber cylinder, thus preventing dirt or other damaging objects from entering inside the preload adjuster causing wear on components. By concealing a surface of the shock absorber cylinder along which the adjuster piston slides during use, the spring guide is further advantageous since said surface is protected from dirt and water to enter between the spring guide and the shock absorber cylinder. Thereby, wear on the spring guide or the shock absorber cylinder is prevented and the risk of wear and leakage at the adjuster piston is reduced.

In accordance with a further embodiment, the spring guide further comprises a protective portion, which protective portion projects from the adjuster piston abutting portion, at an outer radial end portion thereof, and extends in parallel with an exterior lateral surface of the adjuster piston. By providing the protective portion, assembly is facilitated, as well as robustness of the preload adjuster, which is advantageous. The protective portion further provides a protection for the adjuster piston from dirt which could disrupt a correct functioning of the same and reduce the durability of the preload adjuster.

In accordance with a seventh aspect of the present disclosure, there is provided a cylinder head for a shock absorber arrangeable to form an end portion of a shock absorber cylinder, the cylinder head comprises a preload adjuster arrangeable around an exterior circumferential surface of a shock absorber cylinder and operable to generate a displacement of a spring of the shock absorber in an axial direction of the shock absorber cylinder when mounted thereat, wherein at least part of the preload adjuster is housed by the cylinder head.

The disclosure is based on the insight that the cylinder head provided, wherein at least part of a preload adjuster is housed by the cylinder head, enables reduction of parts, which is advantageous since it thereby saves costs for parts and assembly. This reduction is enabled since the cylinder head may act as resistance or anchor for the preload adjuster when applying force on a spring during preloading thereof. Thereby, as opposed to a system where a preload adjuster is independently placed on a shock absorber away from the cylinder head, structural enforcing parts necessary to anchor the preload adjuster may be removed.

In accordance with an embodiment, the cylinder head comprises a head portion and a cylindrical portion, which cylindrical portion is arrangeable around an end of a shock absorber cylinder, wherein the cylindrical portion comprises an elongated inner recess extending around the inner perimeter of the cylindrical portion and wherein the preload adjuster is arranged at least partly in the inner recess. This provides a compact and efficient cylinder head.

In accordance with an embodiment, the preload adjuster comprises a preload chamber and an adjuster piston, wherein the preload chamber and the adjuster piston are arranged at the inner recess of the cylinder head.

In accordance with a further embodiment, the preload adjuster further comprises a spring guide arrangeable around an exterior circumferential surface of a shock absorber cylinder and extending, in the axial direction of the shock absorber cylinder, from an adjuster piston abutting portion of the spring guide, arranged to abut an end of the adjuster piston, to a spring abutting portion of the spring guide, arranged to abut an end of a spring of the shock absorber onto which the cylinder head is mounted, wherein the spring guide is axially displaceable.

By providing a spring guide, the adjuster piston does not have to be in direct contact with the spring. This is advantageous since the adjuster piston does not have to be exposed to forces generated by the spring when displaced. The spring guide can easily be replaced if worn down, which is advantageous. Also, the spring may, when displaced during preloading, generate rotational forces around the axial direction of the shock absorber cylinder. By providing a spring guide which may freely rotate around the axial direction of the shock absorber cylinder, the spring guide may by rotation divert the non-rotational forces potentially generated by the spring. This is advantageous since the spring guide may relieve the adjuster piston from undesired forces and moments when mounted at a shock absorber cylinder.

In accordance with a further embodiment, the spring guide further comprises a stabilizer portion, which stabilizer portion projects from the spring abutting portion at an inner radial end portion thereof in a direction away from the adjuster piston abutting portion.

The stabilizer portion is advantageous because it, by being restrained against the outer shock absorber cylinder when mounted thereat, maintains the spring guide in its intended radial position. A further advantage is that it increases stability of the spring guide since by its extension, it improves its capacity to withstand rotational or pivoting forces caused by the spring.

In accordance with a further embodiment, the spring guide further comprises a protective portion, which protective portion projects from the adjuster piston abutting portion, at an outer radial end portion thereof, and extends in parallel with an exterior lateral surface of the adjuster piston.

By providing the protective portion, assembly is facilitated, as well as robustness of the preload adjuster, which is advantageous. The protective portion further provides a protection against, e.g., dirt or other damaging objects entering the adjuster piston.

According to an aspect, there is provided a hydraulic actuator as disclosed herein for use in a vehicle, such as a 2-wheeled vehicle or a 4-wheeled vehicle.

According to an aspect, there is provided a system as disclosed herein for use in a vehicle, such as a 2-wheeled vehicle or a 4-wheeled vehicle.

It is further noted that the inventive concepts relate to all possible combinations of features unless explicitly stated otherwise.

Effects and features of the second, third, fourth, fifth, sixth and seventh aspects are largely analogous to those described above in connection with the first aspect.

Embodiments mentioned in relation to the first aspect are largely compatible with the second, third, fourth, fifth, sixth and seventh aspects. It is further noted that the inventive concepts relate to all possible combinations of features unless explicitly stated otherwise.

The invention is defined by the appended independent claims, with embodiments being set forth in the appended dependent claims, in the following description and in the drawings. It is to be understood that this disclosure is not limited to the particular component parts of the device described or steps of the methods described as such device and method may vary. It is also to be understood that the terminology used herein is for purpose of describing particular embodiments only, and is not intended to be limiting. It must be noted that, as used in the specification and the appended claims, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings do not exclude other elements or steps.

### BRIEF DESCRIPTION OF THE DRAWINGS

The disclosure is described in the following illustrative and non-limiting detailed description of exemplary embodiments, with reference to the appended drawings, wherein:

FIG. 1 is a schematic illustration of a hydraulic actuator according to an embodiment of the present disclosure.

FIG. 2 is a schematic illustration of a hydraulic actuator according to an embodiment of the present disclosure.

FIG. 3 is a schematic illustration of a hydraulic actuator according to an embodiment of the present disclosure.

FIG. 4 is a schematic illustration of a hydraulic actuator according to an embodiment of the present disclosure.

FIGS. 5a-b show schematic illustrations of a valve comprised in a hydraulic actuator according to an embodiment of the present disclosure.

FIGS. 6a-b show schematic illustrations of a valve comprised in a hydraulic actuator according to an embodiment of the present disclosure.

FIGS. 7a-7c are schematic illustrations of a hydraulic actuator according to an embodiment of the present disclosure.

FIG. 8 is a schematic illustration of a hydraulic actuator according to an embodiment of the present disclosure.

FIGS. 9a-b show schematic illustrations of a valve member comprised in a hydraulic actuator according to an embodiment of the present disclosure.

FIG. 10 is a cut-away view of a hydraulic actuator according to an embodiment of the present disclosure.

FIGS. 11a-11c are schematic illustrations of a system for spring preload adjustment of a shock absorber according to an embodiment of the present disclosure.

FIG. 12 shows a schematic flow chart of a method according to an embodiment of the present disclosure.

FIG. 13 is a cross-sectional view of a hydraulic actuator according to an embodiment of the present disclosure;

FIG. 14 is an exploded view of a hydraulic actuator according to an embodiment of the present disclosure.

FIG. 15 a-c are cross-sectional views of three different embodiments of a hydraulic actuator according to the present disclosure;

FIG. 16 is a cut-away view of a hydraulic actuator according to an embodiment of the present disclosure.

FIG. 17 is a perspective view of a system according to an embodiment of a third aspect of the present disclosure.

FIG. 18a-b are sectional views of a shock absorber with an integrated preload adjuster in a non-preloading state and a preloading state, respectively, according to embodiments of the present disclosure.

### DETAILED DESCRIPTION OF EMBODIMENTS

Hereinafter, the disclosure in various aspects will be described with reference to the illustrative drawings. All figures are schematic, not necessarily to scale, and generally only show parts which are necessary in order to elucidate the disclosure, wherein other parts may be omitted or merely suggested. Throughout the figures the same reference signs designate the same, or essentially the same features. Various elements and arrangements are schematically depicted in the drawings for purposes of explanation only and so as to not obscure the description with details that are well known to those skilled in the art. Nevertheless, the attached drawings are included to describe and explain illustrative examples of the disclosed subject matter.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

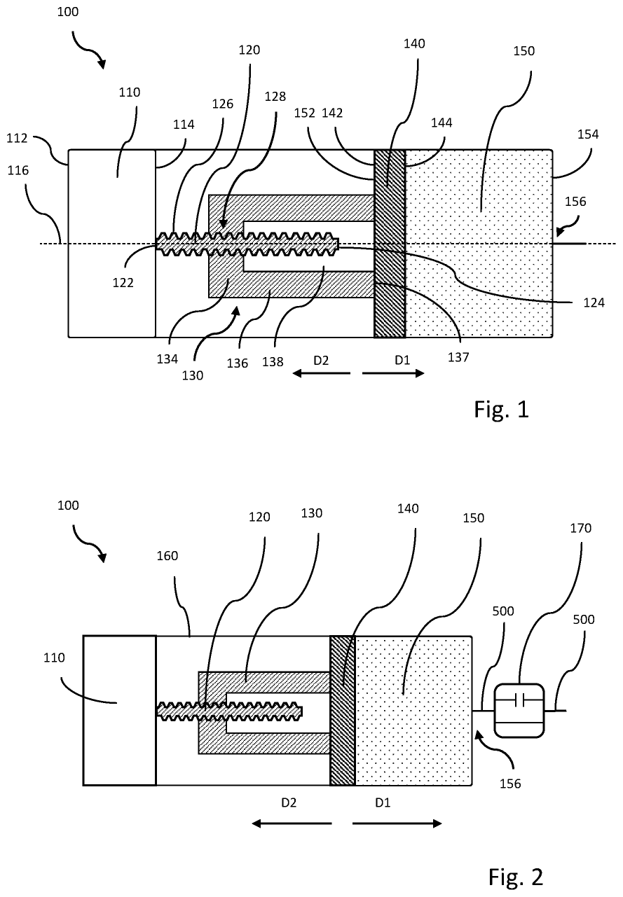

FIG. 1 shows a hydraulic actuator 100 for use with a spring preload adjustment system of a vehicle shock absorber. According to this exemplifying embodiment, there is provided a hydraulic actuator 100 for a spring preload adjustment system for a shock absorber. The hydraulic actuator 100 comprising a fluid chamber 150, a piston 140 slidably arranged within the fluid chamber 150 in a first direction D1 for moving hydraulic fluid out of the fluid chamber 150 to increase spring preload of a shock absorber connected to the hydraulic actuator. The piston 140 is further slidably arranged within the fluid chamber 150 in a second, opposite, direction D2 for allowing hydraulic fluid to enter the fluid chamber 150 to decrease spring preload of the shock absorber. The hydraulic actuator 100 further comprises a drive assembly operatively engageable with the piston 140, comprising a drive unit 110, a lead screw 120 operatively connected to the drive unit 110, and a gear element 130 engaged with the lead screw 120 and arrangeable to abut the piston 140. The drive assembly is operable to actuate the piston 140 to slide in the first direction D1 and is operable to allow the piston 140 to slide in the second direction D2 without the drive unit 110 being actuated. The drive unit 110 has a longitudinal extension along an axis 116 from a first side 112 to a second side 114, which is opposite the first side 112. The drive unit 110 is configured to provide a rotational force. The drive unit 110 may comprise an electric motor, which is able to convert electrical energy into mechanical energy. The electric motor may, for example, be an AC motor or a DC motor. The electric motor may be a brushless motor. Alternatively, the drive unit 110 may comprise a hydraulic motor. The lead screw 120 has a longitudinal extension along the axis 116, from a first lead screw end 122 to a second lead screw end 124. Further, the lead screw 120 comprises an external thread 126, which may extend from the first lead screw end 122 to the second lead screw end 124. A longitudinal axis of the lead screw 120 is coaxial with the axis 116 of the drive unit 110. The lead screw 120 is, at the first end 122 thereof, operatively connected to the drive unit 110, at the second side 114 of the drive unit 110. The lead screw 120 is further, via the external thread 126, in a threaded connection 128 with the gear element 130. The first direction D1 is herein defined as a direction along the axis 116 from the first side 122 of the drive unit 110 towards the second side 114 of the drive unit. The second direction D2 is herein defined as the opposite direction to the first direction D1.

Further, in the exemplifying embodiment shown in FIG. 1, the gear element 130 comprises a base portion 134. The base portion 134 extends away from the lead screw 120 in a direction perpendicular to the axis 116. The base portion 134 may circumferentially extended around the lead screw 120. The gear element 130 further comprises a cylindrical portion 136 which has a longitudinal extension in the first direction D1, from the base portion 134 to a cylindrical portion end 137. The cylindrical portion 136 may be hollow, thus comprising a cylindrical recess 138 having a longitudinal extension along the axis 116 from the base portion 134 to the cylindrical portion end 137. The cylindrical recess 138 is arranged to receive the lead screw 130.

The fluid chamber 150 may extend along the axis 116, in the first direction D1, from a first end 152 to a second end 154, which is opposite the first end 152. The fluid chamber 150 may have a circular cross section extending from the first end 152 to the second end 154. The fluid chamber 150 may comprise an aperture 156 at the second end for hydraulic fluid to enter or exit the fluid chamber 150. As an alternative, the aperture 156 may be arranged at a side surface extending between the first end 152 and the second end 154.

The piston 140 may extend from a first side 142 to a second side 144, which is opposite the first side 142. The first side 142 of the piston 140 is arrangeable to at least partly abut the cylindrical portion end 137 of the gear element 130. The second side 144 delimits the fluid chamber 150 and provides a wall defining the first end 152 of the fluid chamber 150. The second side 144 of the piston 140 may have a surface area which is substantially equal to the circular cross section of the fluid chamber 150. This for preventing hydraulic fluid in the fluid chamber 150 to flow past the piston 140.

It is conceivable to provide fluid chamber, in combination with a piston, with a cross-section of another shape than a circle. Such a cross-sectional shape may be, but is not limited to, an ellipse, a square, a rectangle, etc.

The drive unit 110 may be arranged to actuate the lead screw 120 to rotate around the axis 116 in a first rotational direction. The lead screw 120 may, via the threaded connection 128, be arranged to generate a translation of the gear element 130 in the first direction D1. The gear element may be arranged to engage the piston 140, to actuate the piston 140 to slide in the first direction D1 to move hydraulic fluid out of the fluid chamber 150. The aperture 156 may be arranged for allowing hydraulic fluid to exit the fluid chamber 150.

The drive assembly, comprising the drive unit 110, the lead screw 120, and the gear element 130, may actuate the piston 140 to slide in the first direction D1 via a first engagement, a second engagement and a third engagement. The first engagement may be defined as the operative connection between the drive unit 110 and the lead screw 120. The second engagement may be defined as the threaded connection 128 between the lead screw 120 and the gear element 130. The third engagement may be defined as where the gear element 130 abuts the piston 140. By releasing at least one of the first engagement, the second engagement, or the third engagement, the drive assembly may be operable to allow the piston 140 to slide in the second direction D2 without the drive unit 110 being actuated.

For example, the first engagement may be released by the drive unit 110 being operatively disengaged from the lead screw 120. The piston 140 may thereby slide in the second direction D2, causing the lead screw 120 to rotate without the drive unit 110 being actuated.

The second engagement may be released by releasing the threaded connection between the lead screw 120 and the gear element 130. The piston 140 may thereby slide in the second direction D2, causing the gear element 130 to slide in the second direction D2 without engaging to the lead screw 120 and thus without the drive unit 110 being actuated.

The third engagement may be released by the gear element 130 being disconnected from the piston 140. The drive unit 110 may actuate the gear element 130 to move in the second direction D2 relative the piston 140, enabling the piston to thereafter slide in the second direction D2 until engaging the gear element 130 without the drive unit 110 being actuated.

Further, in the embodiment described with reference to FIG. 1, the drive unit 110 is arranged to provide power transmission via the axis 116. The lead screw 110 is operatively connected to the drive unit 110 and extending therefrom along the axis 116, such that when the drive unit 110 is operated, the lead screw 130 is rotated around the axis 116, thereby transmitting power from the drive unit 110 along the axis 116. The gear element 130 is threadedly engaged with the lead screw 120 such that rotation of the lead screw 110 in a first rotational direction around the axis 116 generates a linear motion of the gear element 130 in the first direction D1 and rotation of the lead screw 130 in a second rotation direction around the axis 116 generates a linear motion of the gear element 130 in the second direction D2.

Now with reference to FIG. 2, an exemplifying embodiment is shown wherein the hydraulic actuator 100 comprises a valve arrangement 170 operable between a closed mode for preventing flow of hydraulic fluid into the fluid chamber 150 and an open mode for allowing flow of hydraulic fluid into the fluid chamber 150. In this shown embodiment, the valve arrangement 170 is arranged at a connector 500. The connector 500 may be arranged such to fluidly connect the fluid chamber 150 to a spring preload adjustment system. The connector 500 may be a hose. The connector 500 may be connected to the fluid chamber 150 via the aperture 156. In an alternative embodiment, the valve arrangement 170 may be fluidly connected directly to the fluid chamber 150 via the aperture 156.

The valve arrangement 170 may, when arranged in the closed mode stop the fluid flow through the aperture 156. Alternatively, if the valve arrangement 170 is arranged on the connector 500, the valve arrangement 170 may close the fluid flow through the connector 500.

The valve arrangement 170 may, when arranged in the open mode, allow fluid flow through the aperture 156. Alternatively, if the valve arrangement 170 is arranged on the connector 500, the valve arrangement 170 may allow fluid flow through the connector 500.

In FIG. 2, the valve arrangement 170 is visualized having a closed mode for preventing flow through the valve arrangement 170, and an open mode for allowing flow through the valve arrangement 170.

The valve arrangement 170 may comprise a check valve for allowing hydraulic fluid to exit the fluid chamber to increase spring preload a shock absorber connected to the hydraulic actuator 100 and preventing backflow. The check valve may advantageously be controllable to be opened for allowing hydraulic fluid to enter the fluid chamber 150 to decrease spring preload of the shock absorber.

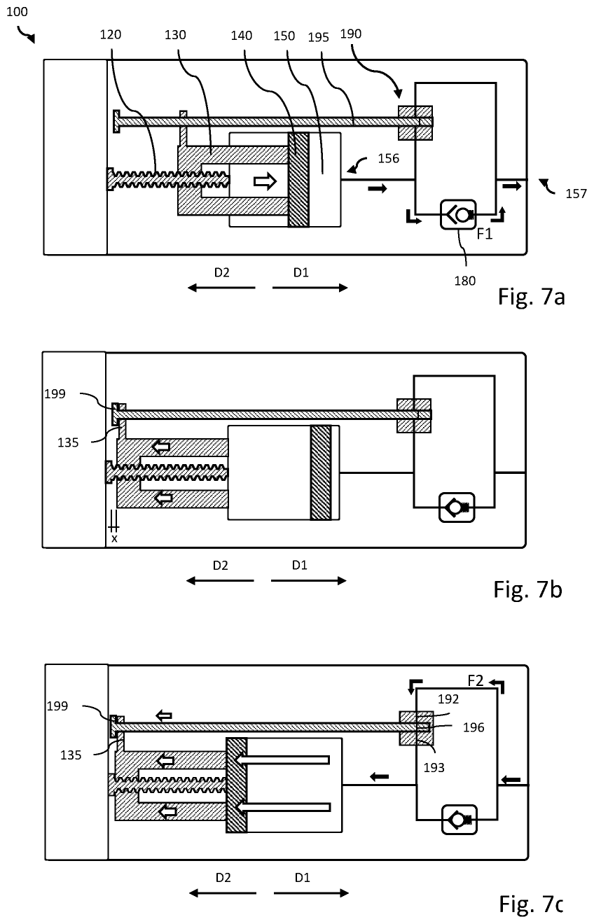

In one exemplary embodiment, the gear element 130 is movable in the second direction D2 relative to the piston 140, as described further with reference to FIGS. 7a-c and 8a-c. The gear element 130 may abut the piston 140 such that it is not attached thereto. This enables the gear element 130 to move freely from the piston 140 in the second direction D2. By moving freely it may be meant that the gear element 130 is not engaged with the piston 140 when moved in the second direction D2. The drive unit 110 may rotate the lead screw 120 in a second rotational direction, which is opposite the first rotational direction. The lead screw 120 will thereby generate a translation of the gear element 130 in the second direction D2 away from the piston 140.

In one exemplary embodiment, the valve arrangement 170 comprises a solenoid valve. A solenoid valve may advantageously be used for regulating hydraulic fluid flow entering and or exiting the fluid chamber. As further shown in FIG. 2, the hydraulic actuator 100 comprises a housing 160 which houses the fluid chamber 150, the piston 140, and the drive assembly, wherein the valve arrangement 170 is arranged external to the housing 160. The housing 160 is arranged around the fluid chamber 150, the piston 140 and the drive assembly, to provide a shell therefor. By providing the housing 160 the packaging of the hydraulic actuator 100 is facilitated.

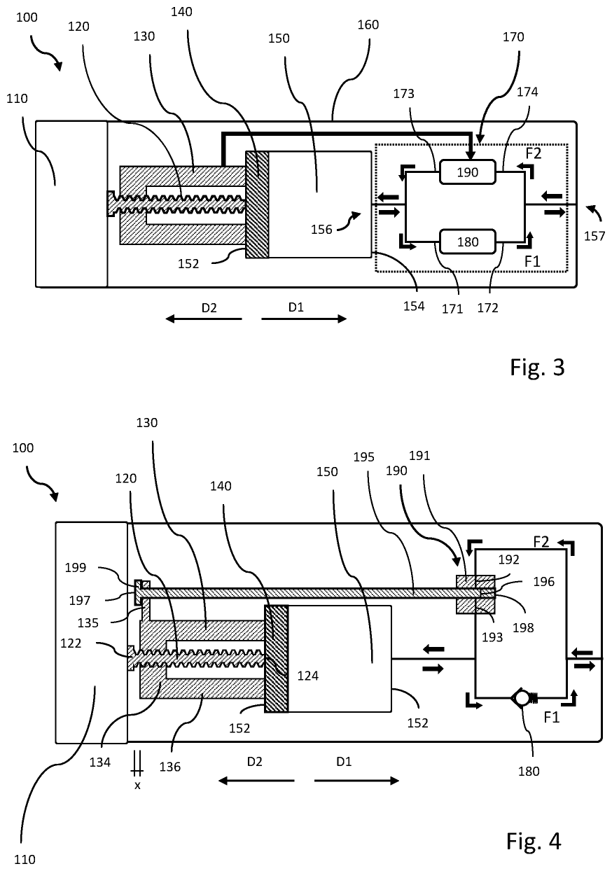

Now with reference to FIG. 3. In this exemplifying embodiment, the hydraulic actuator 100 comprises a housing 160 which houses the fluid chamber 150, the piston 140, the drive assembly, and the valve arrangement 170. The housing 160 is thus arranged around the fluid chamber 150, the piston 140, the drive assembly, and the valve arrangement 170 to provide a shell therefor. As further shown in this embodiment, the valve arrangement 170 comprises a first valve 180 for regulating a first fluid flow path F1 for moving hydraulic fluid out of the fluid chamber 150 to increase spring preload of the shock absorber and a second valve 180 for regulating a second fluid flow path F2 for moving hydraulic fluid into the fluid chamber 150 to decrease spring preload of the shock absorber. The first valve 180 may regulate the first fluid flow path F1 to be open or closed. When the first valve 180 regulates the first fluid flow path F1 to be open, the first fluid flow path F1 may be arranged to fluidly connect the fluid chamber 150 and a port 157 of the hydraulic actuator 100. The port 157 may be arranged at an exterior surface of the hydraulic actuator 100. The port 157 may be arranged to be fluidly connected to a spring preload adjustment system. The first valve 180 may be arranged to be fluidly connected to the fluid chamber 150 via a first channel 171 and the aperture 156. The first valve 180 may be arranged to be fluidly connected to the port 157 via a second channel 172. The second valve 190 may regulate the second fluid flow path F2 to be open or closed. When the second valve 190 regulates the second fluid flow path F2 to be open, the second fluid flow path F2 may be arranged to fluidly connect the fluid chamber 150 to the port 157. The second valve 190 may be arranged to be fluidly connected to the fluid chamber 150 via a third channel 173 and the aperture 156. The first valve 180 may be arranged to be fluidly connected to the port 157 via a fourth channel 174. The first channel 171 and the third channel 173 may be interconnected such that both are arranged to be fluidly connected to the fluid chamber 150 via the aperture 156. Alternatively, each of the first channel 171 and the third channel 173 may be arranged to be independently fluidly connected to the fluid chamber 150. The second channel 172 and the fourth channel 174 may be interconnected such that both are arranged to be connected to the port 157. Alternatively, each of the second channel 172 and the fourth channel 174 may be arranged to be independently fluidly connected to separate ports. The first fluid flow path F1 has advantageously a larger cross-sectional area perpendicular to the flow direction than the second fluid flow path F2. Specifically, the smallest cross-sectional area perpendicular to the flow in the first fluid flow path F1 is advantageously larger that the smaller cross-sectional area perpendicular to the flow in the second fluid flow path F2.

In one exemplary embodiment, the first valve 180 is a check valve. The check valve is advantageously arranged such allow hydraulic fluid to exit the fluid chamber 150 via the first fluid flow path F1 and prevent backflow. By the term check valve, it may be meant a valve allowing fluid to flow along a first direction and substantially prevents the flow in the opposite direction.

In the exemplifying embodiment shown in FIG. 3, the second valve 190 is controlled by the gear element 130. The second valve 190 may regulate the second fluid flow path F2 to be open or closed in response to the movement of the gear element 130. The gear element 130 may control the second valve 190 by motion in the first direction D1 and/or the second direction D2. The motion may be relative the fluid chamber 150, or another stationary component of the hydraulic actuator 100. The motion of the gear element 130 may trigger electrical signals controlling the second valve 190.

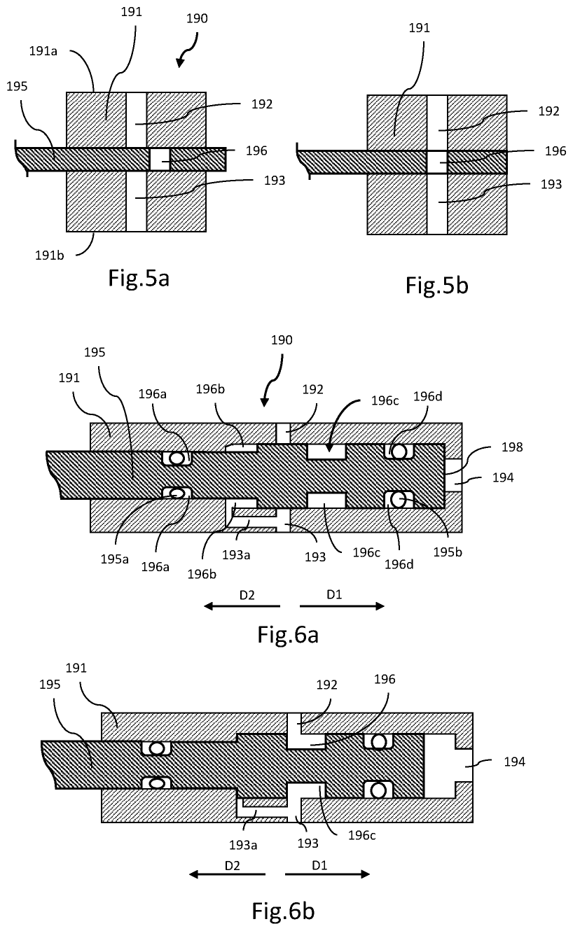

In one exemplary embodiment, the second valve 190 is a spool valve. By the term spool valve, it may be meant a valve that utilizes a movable cylindrical spool within a housing to regulate fluid flow. Now with reference to FIG. 4. In this exemplifying embodiment, the second valve 190 comprises a valve body 191 providing an inlet 192 and an outlet 193. The second valve 190 further comprises a valve member 195 adapted to be movable relative to the valve body 191 between a first position to fluidly disconnect the inlet 192 and the outlet 193 such that the second fluid flow path F2 is closed and a second position to fluidly connect the inlet 192 and the outlet 193 such that the second fluid flow path F2 is open. The valve member 195 is pretensioned into the first position. The gear element 130 is arrangeable to engage the valve member 195 when moved in the second direction D2 to a predetermined point for moving the valve member 195 from the first position to the second position as the gear element 130 is further moved in the second direction D2. The second valve 190 of this embodiment is shown in detail in FIGS. 5a and 5b. The valve member 195 is in the first position in FIG. 5a. The valve member 195 is in the second position in FIG. 5b. The valve body 191 may extend from a first end 191a to a second end 191b, which is opposite the first end 191a. The valve body 191 may be cylindrical, or square. The valve body 191 may be integrated in a structural design of the hydraulic actuator. The valve member 195 may extend through the valve body 191, such that it is movable relative the valve body 191. The inlet 192 may extend from the first end 191a of the valve body 191 to the valve member 195. The outlet 193 may extend from the valve member 195 to the second end 191b of the valve body 191. The valve member 195 may provide a valve member chamber 196. In FIG. 5a the valve member 195 is shown in the first position where it is arranged to fluidly disconnect the inlet 192 and the outlet 193. In FIG. 5b the valve member 195 is in the second position where the valve member chamber 196 may be arranged to fluidly connect the inlet 192 and the outlet 193. The valve member 195 may be pretensioned into the first position by means of a spring actively pressurizing the valve member 195 into the first position. Now with reference to FIG. 4. The valve member 195 may have a longitudinally extension, along or in parallel with the axis 116, in the first direction D1, from a first end 197 to a second end 198. The valve member 195 may further provide a valve member protrusion 199. The protrusion 199 may protrude away from the longitudinal extension of the valve member 195 in a direction which is perpendicular thereto.

The gear element 130 may further provide a gear element protrusion 135. The gear element protrusion 135 is arranged to engage the valve member protrusion 199 when the gear element 130 is at the predetermined point such that, when the gear element 130 is moved further in the second direction D2, the valve member 195 is moved to the second position. The gear element 130 may have a range of motion along the lead screw 130 from a first point where the gear element 130 is threaded connection with the lead screw 120 at the first lead screw end 122, and a second point where it is in threaded connection with the lead screw 120 at the second lead screw end 124. The predetermined point may be defined as a point along that range of motion which is spaced a distance x away from where the gear element 130 is in threaded connection to lead screw 120 at the first led screw end 122. The distance x is preferably set to equal the distance the valve member 195 is required to be displaced for moving from the first position to the second position. The gear element protrusion 135 is arranged to freely slide along the valve member 195 when the gear element 130 moves in the first direction D1. The gear element protrusion 135 may encircle, or substantially encircle, the valve member 195.

Now with reference to FIGS. 6a and 6b. In one exemplary embodiment, the valve member 195 is pretensioned into the first position by hydraulic pressure. The valve member chamber 196 may comprise a first portion 196a, a second portion 196b, a third portion 196c, and a fourth portion 196d. The first portion 196a, the second portion 196b, the third portion 196c, and the fourth portion 196d may be arranged such to be fluidly connected to each other. The second portion 196b may be arranged such to be fluidly connected the outlet 193 when valve member 195 is in the first position. The third portion 196c may be arranged to be fluidly connected to the outlet 193 when the valve member 195 is in the second position. Each of the first portion 196a, the second portion 196b, the third portion 196c, and the fourth portion 196d, may circumferentially extend around a centre axis along the longitudinal extension of the valve member 195. A first sealing-ring 195a may be provided in the first portion 196a to seal the first portion 196a. A second sealing-ring 195b may be provided in the fourth portion 196d to seal the fourth portion 196d. The first portion 196a has advantageously a smaller cross-sectional area perpendicular to the longitudinal extension of the valve member 195 than the fourth portion 196d. Thereby, the hydraulic actuator 100 may be arranged such that when operating, hydraulic fluid pressure propagates from the fluid chamber 150, via the outlet 193 to the valve member chamber 196. Since the fourth portion 196d has a larger cross-sectional area than the first portion 196a, the fourth portion 196d will be exposed to larger hydraulic pressure force than the first portion 196a, resulting in that hydraulic pressure pressurizes the valve member 195 to move in the first direction D1 into the first position. It is conceivable that an alternate design of the valve member may allow hydraulic pressure to propagate to the valve member chamber 196 via the inlet 192. FIG. 6a. shows the valve member 195 in the first position. FIG. 6b shows the valve member 195 in the second position. The valve body 191 may provide an air channel 194, or similar, at the second end 198 of the valve member 195 for facilitating the movement of the valve member 195 between the first position and the second position.

Now with reference to FIGS. 7a-c, a procedure of using an embodiment of a hydraulic actuator 100 for increasing and decreasing preload of a preload adjustment system for a shock absorber is described. The hydraulic actuator 100 is at FIGS. 7a-7c connected to a spring preload adjustment system. As shown in FIG. 7a, the drive unit 110 may actuate the lead screw 120 to rotate in the first rotational direction, generating a translation of the gear element 130 in the first direction D1. The gear element 130 may engage with the piston 140 to actuate it to slide in the first direction D1 of the fluid chamber 150. The first valve 180 may be open allowing hydraulic fluid to exit the fluid chamber 150 via the first fluid flow path F1. The valve member 195 may be pretensioned into the first position, thus regulating the second valve 190 to be closed, thereby preventing fluid flow through the second fluid flow path F2.

In FIG. 7b, the drive unit 110 may actuate the lead screw 120 to rotate in the second rotation direction, generating a translation of the gear element 130 in the second direction D2. The first valve 180 may close the first fluid flow path F1 to prevent backflow. Since the first valve 180 and the second valve 180 are both closed for flow into the fluid chamber 150, the piston 140 is unable to slide inside the fluid chamber 150. The gear element 130 thus moves in the second direction D2 relative the piston 140. The gear element 130 may move in the second direction D2 until reaching the predetermined point. When the gear element 130 is arranged at the predetermined point the gear element protrusion 135 may engage the valve member protrusion 199.

In FIG. 7c, the drive unit 110 may further rotate the lead screw 130 in the second rotation direction which causes the gear element 130 to move further in the second direction D2. The gear element 130 engages the valve member 195 to move in the second direction D2, thus controlling the second valve 190 to open and regulate the second fluid flow path F2 to be open. Hydraulic fluid may thereby enter the fluid chamber 150 via the second fluid flow path F2. The piston 140 may slide in the second direction D2 without the drive unit 110 being actuated.

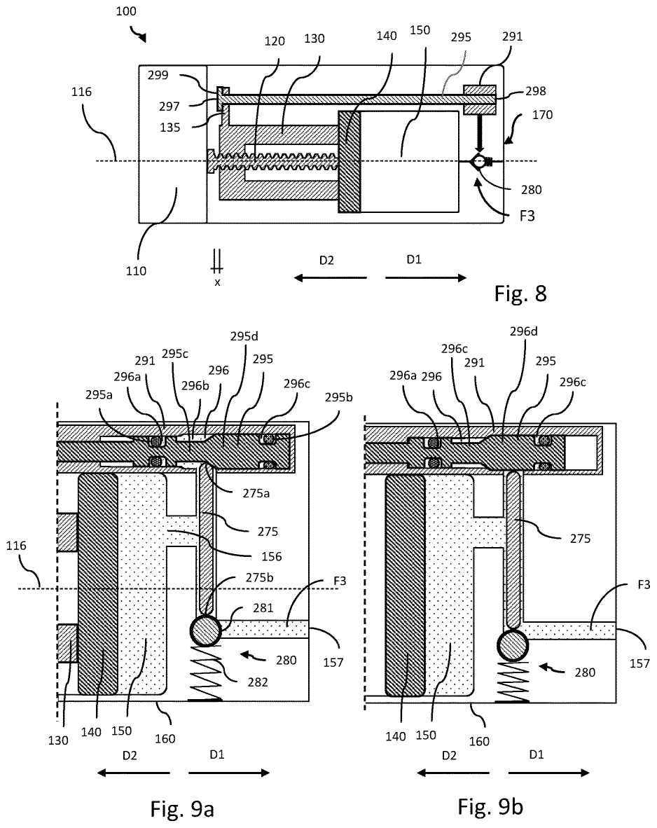

Now with reference to FIG. 8, in one exemplary embodiment, the valve arrangement 170 comprises a valve body 291, a valve member 295 adapted to be movable relative to the valve body 291 between a first position to control the valve arrangement 170 to be in the closed mode and a second position to control the valve arrangement 170 to be in the open mode. The gear element 130 is arrangeable to engage the valve member 295 when moved in the second direction D2 to a predetermined point for moving the valve member 295 from the first position to the second position as the gear element 130 is further moved in the second direction D2. The valve body 291 may be integrated in a structural design of the hydraulic actuator 100. Alternatively, it may be an interior component of the hydraulic actuator 100. The valve member 295 may have a longitudinal extension in parallel with the axis 116, in first direction D1, from a first end 297 to a second end 298. The valve member 295 may, at the first end 297 thereof, comprise a valve member protrusion 299. The valve member protrusion 299 may protrude away from the longitudinal extension of the valve member 295 in a direction which is perpendicular thereto. The valve member 295 may extend through the valve body 291, such that it is movable relative the valve body 291 between the first position and the second position. The valve member 295 is shown in the first position in FIG. 9a. The valve member 295 is shown in the second position in FIG. 9b. As shown in FIG. 9a, the valve member 295 may provide a valve member chamber 296 comprising a first portion 296a, a second portion 296b and a third portion 296c. The first, second, and third portions 296a, 296b, 296c are arranged to be fluidly connected to each other. The valve member chamber 296 is arranged to be fluidly connected to the fluid chamber 150 when the valve member 295 is in the first position and the second position.

Each of the first, the second, and the third portion 296a, 296b, 296c may circumferentially extend around a centre axis along the longitudinal extension of the valve member 295. A first Sealing-ring 295a may be provided in the first portion 296a to seal the first portion 296a. A second Sealing-ring 295b may be provided in the third portion 296d to seal the third portion 296d. The valve member 295 may provide a thin portion 295c and a thick portion 295d, wherein the thin portion 295c has a smaller cross-sectional radius than the thick portion 295d. The cross-sectional radius may be defined as a length from a longitudinal centre axis of the valve member 295 to an outer edge of the cross section of the valve member 295, in a perpendicular direction away from the longitudinal centre axis. The valve member 295 may provide an, in relation to the longitudinal extension of the valve member 295, angled surface extending from the thin portion 295c to the thick portion 295d.

The valve arrangement may provide a third fluid flow path F3 which is arranged to fluidly connect the fluid chamber 150 and the port 157 of the hydraulic actuator 100. A first flow direction of the third fluid flow path F3 may be defined as a flow direction along the third fluid flow path F3 from the fluid chamber 150 to the port 157. A second flow direction may be defined as the opposite direction. The smallest cross-sectional size of the third fluid flow path F3 is advantageously adapted in flow-through area for tuning the flow resistance when increasing spring preload and reducing spring preload. The valve arrangement may further comprise a check valve 280. The check valve 280 may be arranged to allow hydraulic fluid to exit the fluid chamber 150 via the third fluid flow path F3 and to prevent backflow. The check valve 280 may comprise a ball head 281 and a spring 282. The ball head 281 may be movable relative the third fluid flow path F3 between a closed position where it blocks the hydraulic fluid flow through the third fluid flow path F3 and an open position where it allows hydraulic fluid to flow through the third fluid flow path F3. The spring 282 is arranged to apply a force to the ball head 281 in the second flow direction such that the ball head 281 moves to its closed position. When the piston 140 slides in the first direction D1 for moving hydraulic fluid out of the fluid chamber 150 via the third fluid flow path F3, the ball head 282 is arranged to move into its open position in response to hydraulic fluid pressure in the third fluid flow path F3. When hydraulic fluid flows in the second flow direction the ball head 281 is arranged to move into its closed position in response to the spring 282. The valve arrangement 170 may further comprise a rod arrangement 275 with a longitudinal extension from a first end 275a to a second end 275b. The rod arrangement 275 may comprise one or multiple rods. The rod arrangement 275 may comprise a spherical shaped element or similar. The rod arrangement 275 is movably arranged relative the valve body 291 along the longitudinal extension of the rod arrangement 275. The longitudinal extension of the rod arrangement 275 may be perpendicular to the axis 116. The rod arrangement 275 may be located in the third fluid flow path F3. The rod arrangement 275 may advantageously have a shape such to allow hydraulic fluid flow to flow around and along the rod arrangement 275 when the rod arrangement 275 is arranged in the third fluid flow path F3. The rod arrangement 275 may have a length between its first end 275a and its second end 275b such that when the ball head 281 is in the closed position, and the valve member 295 is in the first position, the first end 275a of the rod arrangement 275 abuts the thin portion 295c of the valve member, and the second end 275b of the rod arrangement 275 abuts the ball head 281. When the valve member 295 is in the first position, the check valve 280 may be arranged to allow hydraulic fluid to exit the fluid chamber 150 via the third fluid flow path F3 and the check valve 280 may prevent backflow.

In FIG. 9b, the valve member 295 is shown in the second position. When the valve member 295 moves in the second direction D2 from the first position to the second position, the valve member 295 moves in the second direction D2 relative the rod arrangement 275. The rod arrangement 275 is arranged such that when the valve member 295 is in the second position, the first end 275a of the rod arrangement 275 may abut the thick portion 295d of the valve member 295. Since the cross-sectional radius of the thick portion 295d of the valve member 295 is larger than the cross-sectional radius of the thin portion 295c, the valve member 295 when moved from the first position to the second position, forces the rod arrangement 275 to move away from the valve member 295 such to, in turn, force the ball head 281 to move towards, or into, the open position. When the valve member 295 is in the second position, the check valve 280 may allow hydraulic fluid to enter the fluid chamber 150 via the third fluid flow path F3.

As shown in FIG. 8, the gear element protrusion 135 is arranged to engage the valve member protrusion 299 when the gear element 130 is at the predetermined point such that, when the gear element 130 is moved further in the second direction D2, the valve member 295 is moved to the second position.

Now with reference to FIGS. 9a and 9b. In one exemplary embodiment, the valve member 295 is pretensioned into the first position by hydraulic pressure. The valve member chamber 296 may be arranged to be fluidly connected to the fluid chamber 150 via the third fluid flow path F3. Alternatively, the valve member chamber may be arranged to be fluidly connected to the fluid chamber 150 via an alternative flow path. The first portion 296a of the valve member fluid chamber 296 may advantageously have a smaller cross-sectional area than the third portion 296c of the valve member chamber 296. Thereby, the hydraulic actuator 100 may be arranged such that when operating, hydraulic fluid pressure propagates from the fluid chamber 150, via the third fluid flow path F3 to the valve member chamber 296. Since the third portion 296c has a larger cross-sectional area than the first portion 296a, the third portion 296d will be exposed to larger hydraulic pressure force than the first portion 296a, resulting in that hydraulic pressure pressurizes the valve member 295 to move in the first direction D1 into the first position. Alternatively, the valve member 295 may be pretensioned into the first position by means of a spring.

When operating the hydraulic actuator 100 described with reference to FIGS. 8, 9a and 9b, the drive unit 110 may actuate the piston 140 to slide in the first direction D1 for moving hydraulic fluid out of the fluid chamber 150. The hydraulic fluid pressure from the fluid chamber 150 may propagate to the valve member chamber 296 such that the valve member 296 is pretensioned into the first position. The check valve 280 may allow hydraulic fluid to exit the fluid chamber 150 via the third fluid flow path F3. The check valve 280 may prevent flow in the second flow direction of the third fluid flow path F3. The hydraulic actuator 100 may thereby, when fluidly connected to a spring preload adjustment system increase spring preload. The drive unit 100 may further actuate the gear element 130 to move in the second direction D2. The check valve 280 may prevent hydraulic fluid from entering the fluid chamber 150 which causes the piston 140 to remain stationary in the fluid chamber 150. The gear element 130 may thereby move in the second direction D2 relative the piston 140. The gear element 130 may move to the predetermined point where the gear element protrusion 135 engages the valve member protrusion 299. The drive unit 110 may actuate the gear element 130 to move further in the second direction D2 to engage the valve member 295 to move into the second position. The valve member 295 will thereby engage the rod arrangement 275 to move the ball head 281 to the open position. The check valve 280 will thereby be opened and, thus, allow hydraulic fluid to flow in the second direction of the third fluid flow path F3. The check valve may thereby allow hydraulic fluid to enter the fluid chamber for decreasing spring preload of a shock absorber adjustment system.

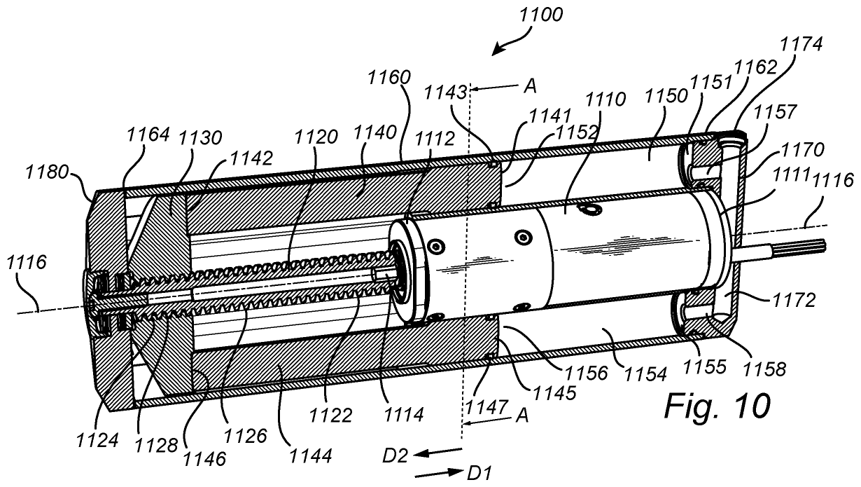

FIG. 10 shows an exemplary embodiment of a hydraulic actuator 1100 comprising a drive unit 1110, a lead screw 1120, a gear element 1130, a first and a second actuator piston 1140, 1144, and a first and a second fluid chamber 1150, 1154. In this embodiment the drive unit 1110 has a longitudinal extension along the axis 1116 and the fluid chamber 1150 has a longitudinal extension along or in parallel with the axis 1116 which longitudinal extension of the fluid chamber 1150 is at least partly overlapping with the longitudinal extension of the drive unit 1110. The hydraulic actuator 1110 may be connected to a spring preload adjustment system. The hydraulic actuator 1100 may comprise the valve arrangement operable between a closed mode for preventing flow of hydraulic fluid into the fluid chamber 1150 and an open mode for allowing flow of hydraulic fluid into the fluid chamber 1150. The valve arrangement may be arranged external to a housing 1160 of the hydraulic actuator 1100. Alternatively, the valve arrangement may be arranged inside the housing 1160. The gear element 1130 may abut the first and the second actuator piston 1410, 1144 such that it is not attached thereto. This enables the gear element 1130 to move freely from the first and the second actuator piston 1410, 1144 in the second direction D2.

Now with reference to FIGS. 9a-9c a system 200 for spring preload adjustment of a shock absorber 300 according to an embodiment of the present disclosure is shown. The system comprising a hydraulic actuator 100 as disclosed herein, a preload adjuster 400 comprising an adjuster piston 420, and a connector 500 defining a fluid flow connection between the hydraulic actuator 100 and the preload adjuster 400. The adjuster piston 420 is operable by the hydraulic actuator 100 to move in an axial direction of a shock absorber cylinder 310 onto which it is mounted, and arrangeable to act on a spring 330 of the shock absorber 300 such to affect the preload of the same. The shock absorber 300 may comprise a hydraulic cylinder 310, a shock absorber piston assembly 320 and a spring 330. The hydraulic cylinder 310 may have a longitudinal extension along an axis of the shock absorber 300. The shock absorber piston 320 assembly may comprise a piston 322 and a piston rod 324. The piston assembly 320 may be movable relative the hydraulic cylinder along the longitudinal axis of the hydraulic cylinder 310 between an extended position and a compressed position. The shock absorber 300 may further comprise a top platform 302 and a bottom platform 304. The top platform 302 is connected to an upper end of the hydraulic cylinder 310. The bottom platform 304 may be connected to a lower end of the piston assembly 320. The preload adjuster 400 may be mounted on an upper portion of the hydraulic cylinder 310. The preload adjuster 400 may comprise a preload chamber 410 and an adjuster piston 420 which is slidable within the preload chamber 410. The preload adjuster 400 further comprise a preload platform 430 arranged so as to abut the adjuster piston 420 on a first side, and to abut the spring 330 on a second opposite side. The spring 330 extends between the preload platform 420 and the bottom platform 304. In the shown embodiment, a valve arrangement 170 is arranged on the connector 500 to regulate the fluid flow through the connector 500 between open and closed. Alternatively, the valve arrangement 170 may be arranged inside the housing 160 of the hydraulic actuator 100. The connector 500 may define a fluid flow connection between the preload chamber 410 of the preload adjuster 400 and the fluid chamber 150 of the hydraulic actuator 100.

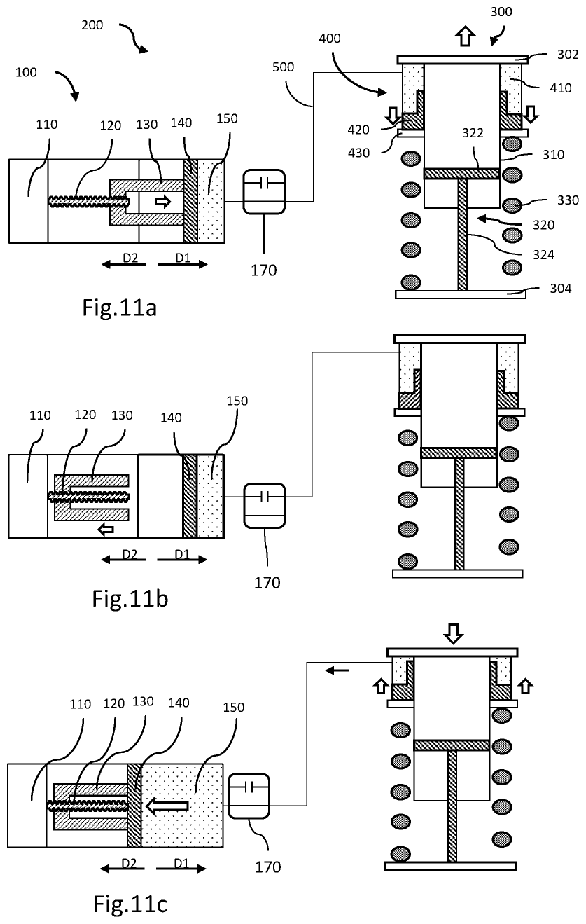

Now with reference to FIG. 11a, the system 200 may preload the spring 330 by the drive unit 100 actuating the lead screw 120 to rotate in the first rotation direction. This generates a linear translation of the gear element 130 in the first direction D1. The gear element 130 engages the piston 140 to slide in the first direction D1 to move hydraulic fluid out of the fluid chamber 150. In FIG. 11a, the valve arrangement 170 regulates the fluid flow through the connector 500 to be open. Hydraulic fluid exiting the fluid chamber 150 enters the preload chamber 410 causing the adjuster piston 420 to slide along the longitudinal extension of the hydraulic cylinder 310 displacing the adjuster platform 430, which in turn preloads the spring 330. As the preload increases, the distance between the top platform 302 and the bottom platform 304 increases. This may increase the ride height of a vehicle connected to the shock absorber 300. As shown in FIG. 11b, the valve arrangement 170 regulates the fluid flow through the connector 500 to be closed. This is advantageous for maintaining the desired preload of the spring 330. Additionally, it allows for the drive unit 100 to actuate the gear element 130 to move in the second direction D2 relative the piston 140. As shown in FIG. 11c. the valve arrangement 170 may regulate the fluid flow in the connector 500 to be open. Thereby, hydraulic fluid is allowed to exit the preload cylinder 410 and enter the fluid chamber 150. As the preload of the spring 330 decreases, the distance between the top platform 302 and the bottom platform 304 decreases. This may decrease the ride height of a vehicle connected to the shock absorber 300. As an alternative to the hydraulic actuator 100, the system 200 may comprise a hydraulic actuator 1100 as disclosed herein. In that case, the connector 500 may define a fluid flow connection between the preload chamber 410 of the preload adjuster 400 and the fluid chamber 1150 of the hydraulic actuator 1100.

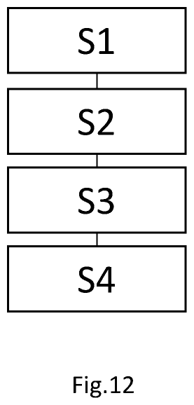

FIG. 12 illustrates schematically a method for adjusting preload of a shock absorber 300. The method comprises providing S1 a hydraulic actuator 100 as disclosed herein, operatively disengaging S2 the drive unit 110 from the piston 140, allowing S3 hydraulic fluid into the fluid chamber 150 such that the piston 140 slides in the second direction D2 for rapidly reducing preload of the shock absorber 300 without the drive unit 110 being actuated. The method may further comprise actuating S4 the piston 140 in the first direction D1 for increasing preload of the shock absorber 300. The step of operatively disengaging S2 the drive unit 110 may further comprise preventing flow of hydraulic fluid into the fluid chamber 150, moving the gear element 130 relative to the piston 140 in the second direction D2; and allowing flow of hydraulic fluid to enter the fluid chamber 150. The step of moving the gear element 130 may further comprise moving the gear element 130 relative to the piston 140 in the second direction D2 into engagement with a valve member 195 of the hydraulic actuator 100, and moving the gear element 130 relative to the piston 140 in the second direction D2 for moving the valve member 195 into the second position for allowing flow of hydraulic fluid to enter the fluid chamber 150.

FIG. 10 shows an embodiment of a hydraulic actuator 1100 comprising a drive unit 1110, a lead screw 1120, a gear element 1130, a first and a second actuator piston 1140, 1144, and a first and a second fluid chamber 1150, 1154. The drive unit 1110 has a longitudinal extension along a centre axis 1116 of the drive unit 1110. The drive unit 1110 comprises a first end 1111 and a second end 1112, wherein the second end 1112 is opposite the first end 1111. The drive unit 1110 is configured to provide a rotational force. The drive unit 1110 may comprise an electric motor, which is able to convert electrical energy into mechanical energy. The electric motor may, for example, be an AC motor or a DC motor. The electric motor may be a brushless motor. Alternatively, the drive unit 1110 may comprise a hydraulic motor. As referred to herein, a second direction D2 is defined as the direction from the first end 1111 of the drive unit 1110 towards the second end 1112 of the drive unit 1110. As referred to herein, a first direction D1 is defined as opposite to the second direction D2.

In the exemplified embodiment, the drive unit 1110 is configured to, at its second end 1112, provide a rotational force, which is rotational around the axis 1116 of the drive unit 1110.

The drive unit 1110 comprises a connecting portion 1114 at its second end 1112. The connecting portion 1114 is connected to the lead screw 1120 at a first lead screw end 1122. The lead screw 1120 has a longitudinal extension along the axis 1116, from the first lead screw end 1122 to a second lead screw end 124. Further, the lead screw 1120 has an external thread 1126, which may extend from the first lead screw end 1122 to the second lead screw end 1124. A longitudinal axis of the lead screw 1120 is coaxial with the axis 1116 of the drive unit 1110. The lead screw 1120 is, via the external thread 1126, in a threaded connection 1128 with the gear element 1130. The gear element 1130 is here a lead screw nut 1130 which is mounted at the lead screw 1120 and, thus, in a threaded connection 1128 therewith. The lead screw nut 1130 has an internal thread which matches the external thread 1126 of the lead screw 1120

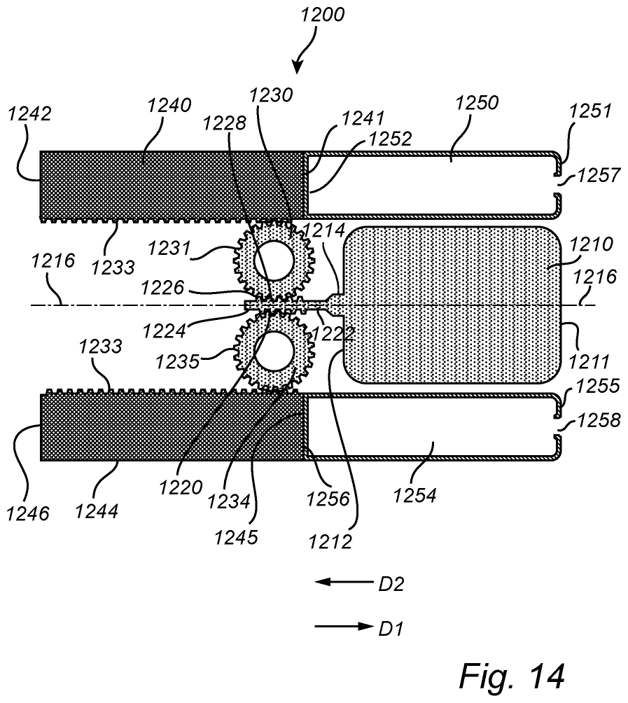

In the exemplifying embodiment shown in FIG. 10, the lead screw nut 1130 comprises opposing first and second lateral flange portions 1131, 1132, as best seen in FIG. 14. The first lateral flange portion 1131 is connected to the first actuator piston 1140, and the second lateral flange portion 1132 is connected to the second actuator piston 1144 at second ends 1142, 1146 of the respective first and second actuator piston 1140, 1144. Each of the first and the second actuator pistons 1140, 1144 extends longitudinally, in the first direction D1, in parallel with the axis 1116, from the second end 1142, 1146, to a first end 1141, 1145 of the respective actuator piston 1140, 1145. The second end 1142, 1146 of each of the first and second actuator pistons 1140, 1144 is connected to the gear element 1130 such that the longitudinal extension of each of the first and second actuator pistons 1140, 1144 extends in parallel with the longitudinal extension of the lead screw 1120 and/or the drive unit 1110, at opposite sides thereof.

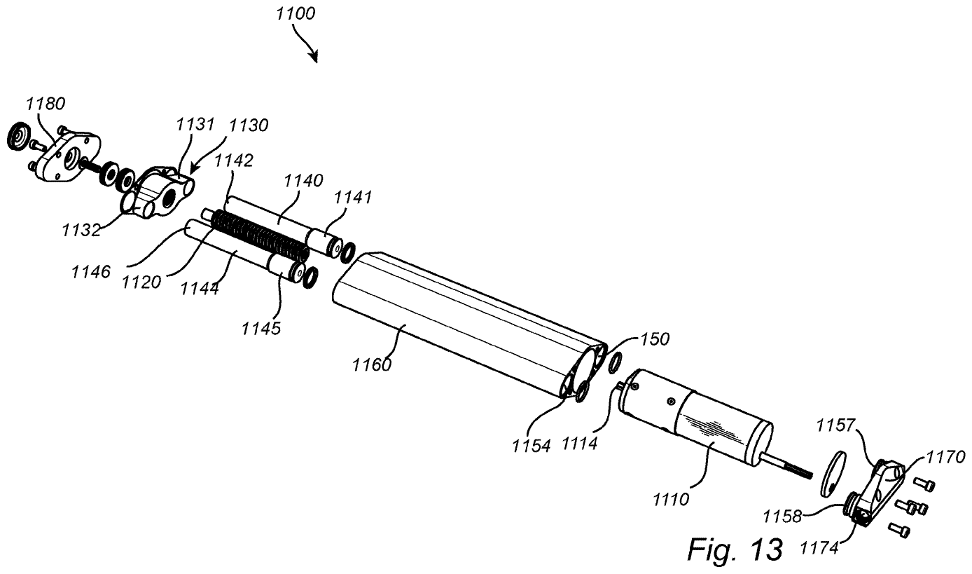

Further, in this exemplifying embodiment, the hydraulic actuator 1100 comprises the first and a second fluid chambers 1150, 1154. Each of the first and second fluid chamber 1150, 1154 is positioned such that the respective first and second actuator piston 1140, 1144 is slidable therein. Each of the first and second fluid chambers 1150, 1154 extends longitudinally, in parallel with the axis 1116, from a second end 1152, 1156, to a first end 1151, 1155 of the respective fluid chamber 1150, 1154. The longitudinal extension of the first and the second fluid chamber 1150, 1154 extends in parallel with the longitudinal extension of the drive unit 1110, at opposite sides thereof. More particularly, the longitudinal extension of each of the first and second fluid chamber 1150, 1154 overlaps with the longitudinal extension of the drive unit 1110. That is, the first and the second fluid chambers 1150, 1154 extend longitudinally at opposite sides along the longitudinal extension of the drive unit 1110. The cross-section of the first and second fluid chamber 1150, 1154 is in this exemplifying embodiment circular, as better seen in FIG. 13 showing an exploded view of the hydraulic actuator 1100. However, providing fluid chambers with a cross-section of another shape, in combination with first and second actuator pistons 1140, 1144 of a corresponding shape, is also conceivable within the concept of the present disclosure. Such a cross-sectional shape may be, but is not limited to, an ellipse, a square, a rectangle, etc. The first and second fluid chambers 1150, 1154 are arranged to receive and contain hydraulic fluid.

Each of the first ends 1151, 1155 of the first and second fluid chamber 1150,154 comprises an aperture 1157, 1158. The function of the aperture 1157, 1158 is to enable hydraulic fluid to exit and enter the first and the second fluid chamber 1150, 1154 upon movement of a respective actuator piston 1140, 1144 therein.

The first and second actuator piston 1140, 1144 are slidable inside the first and second fluid chamber 1150, 1154, respectively. Each of the first and second actuator piston 1140, 1144 is slidable in the second direction D2, for moving hydraulic fluid into the first and second fluid chamber 1150, 1154, via the aperture 1157, 1158, respectively. Each of the first and second actuator piston 1140, 1144 is further slidable in the first direction D1, for moving hydraulic fluid out of the first and second fluid chamber 1150, 1154, via the aperture 1157, 1158, respectively. The first and second actuator pistons 1140, 1144 may be any standard piston used for moving hydraulic fluid. In this exemplifying embodiment, each of the first and second actuator piston 1140, 1144 further comprises an O-ring 1143, 1147 arranged around a circumference of the first end 1141, 1145 of the respective actuator piston 1140, 1144, for sealing purposes.

The drive unit 1110 is configured to provide a rotational force in a first rotational direction for rotating the lead screw 1120, via the connecting portion 1114, in a first rotational direction around the axis 1116 of the drive unit 1110. When the lead screw 1120 rotates in the first rotational direction around the axis 1116, the external thread 1126 will then, via the threaded connection 1128, induce a linear motion of the gear element 1130 in the second direction D2. Since the gear element 1130 is connected to the first and second actuator pistons 1140, 1144, the linear motion of the gear element 1130 in the second direction D2 causes each of the first and second actuator piston 1140, 1144 to slide in the second direction D2 within the respective first and the second fluid chamber 1150, 1154, for moving hydraulic fluid into the first and second fluid chambers 1150, 1154, via the respective aperture 1157, 1158. Thereby, each of the first and second actuator piston 1140, 1144 is operatively connected to the drive unit 1110.

The drive unit 1110 is further configured to provide a rotational force in a second rotational direction for rotating the lead screw 1120, via the connecting portion 1114, around the axis 1116 of the drive unit 1110. The external thread 1126 of the lead screw 1120 will then, via the threaded connection 1128, induce a linear motion of the gear element 1130 in the first direction D1. The gear element 1130 will thereby cause each of the first and the second actuator piston 1140, 1144 to slide in the first direction D1 within the respective fluid chamber 1150, 1154 for moving hydraulic fluid out of the first and second fluid chambers 1150, 1154, via the respective aperture 1157, 1158.

The hydraulic actuator 1100 further comprises a housing 1160 for housing the drive unit 1110, the first and second actuator pistons 1140, 1144 and the first and second fluid chambers 1150, 1154. The housing 1160 has a longitudinal extension along the axis 1116 from a first housing end 1162 to a second housing end 1164. The hydraulic actuator 1100 comprises a first end cap 1170 connected to the housing 1160 at the first housing end 1162, and a second end cap 1180 connected to the housing at the second housing end 1164. The first and the second end caps 1170, 1180 seal the housing 1160 at respective ends thereof and may thereby ensure that the components housed by the housing 1160 are secured. The first end cap 1170 comprises a compartment 1172. The compartment 1172 is connected to the first and second fluid chambers 1150, 1154 via the first and the second aperture 1157, 1158, respectively. The compartment 1172 further comprises a channel 1174. The channel 1174 extends from the compartment 1172 through a wall portion of the first end cap 1170 to an exterior surface thereof. During operation of the hydraulic actuator 1100, hydraulic fluid exiting the first and the second fluid chambers 1150, 1154 is gathered in the compartment 1172. The hydraulic fluid may further exit the hydraulic actuator 1100 through the channel 1174. Alternatively, hydraulic fluid may enter the hydraulic actuator 1100 via the channel 1174, and further, via the compartment 1172 and the first and second apertures 1157,158, enter the first and second fluid chambers 1150, 1154, respectively.

With reference to FIG. 14, another embodiment of the hydraulic actuator 1200 is shown. In this embodiment, the hydraulic actuator 1200 comprises a drive unit 1210, a lead screw 1220, a first and a second gear element 1230, 1234, a first and a second actuator piston 1240, 1244 and a first and a second fluid chamber 1250, 1254. As in the embodiment described with reference to FIG. 10, the drive unit 1210 of this exemplifying embodiment has a longitudinal extension along a centre axis 1216 of the drive unit 1210. The drive unit comprises a first end 1211 and a second end 1212, which is opposite the first end 1211. As referred to herein, a second direction D2 is defined as the direction from the first end 1211 of the drive unit 1210 towards the second end 1212 of the drive unit 1210, i.e., from right to left in FIG. 14. A first direction D1 is defined as opposite to the second direction D2, i.e., from left to right in FIG. 14. The drive unit 1210 is configured to provide a rotational force around the axis 1216 of the drive unit 1210. The drive unit 1210 comprises a connecting portion 1214 at its second end 1212. The connecting portion 1214 is rotatably connected to the lead screw 1220 at a first lead screw end 1222. The lead screw 1220 has a longitudinal extension along the axis 1216, from the first lead screw end 1222 to a second lead screw end 1224. Further, the lead screw 1220 comprises an external thread 1226, which extends from the first lead screw end 1222 to the second lead screw end 1224. The longitudinal axis of the lead screw 1220 is aligned with the axis 1216. The lead screw 1220 is in this exemplifying embodiment a worm 1220 which is engaged with the first and second gear part 1230, 1234, here first and second worm gears 1230, 1234. The first and second worm gear 1230, 1234 are positioned at opposite sides of the lead screw 1220, with respect to the axis 1216. Each of the first and second gear part 1230, 1234 comprises a toothed edge 1231, 1235 which extends circumferentially around the perimeter of the respective gear part 1230, 1234. The toothed edge 1231, 1235 of each of the first and second gear part 1230, 1234 is connected with the external thread 1226 of the lead screw 1220.

Each of the first and the second actuator piston 1240, 1244 extends longitudinally in parallel with the axis 1216, from a second end 1242, 1246, to a first end 1241, 1245. The longitudinal extension of the first and second actuator piston 1240, 1244, extends in parallel with the longitudinal extension of the lead screw 1220, at opposite sides thereof. In this exemplifying embodiment, each of the first and second actuator piston 1240, 1244 comprises a rack portion 1233, the teeth of which are arranged to be meshed with the toothed edge 1231, 1235 of the first and second worm gears 1230, 1234.

Further, each of the first and second fluid chamber 1250, 1254 extends longitudinally, in the first direction D1, in parallel with the axis 1216, from a second end 1252, 1256, to a first end 1251, 1255, respectively. The first and the second fluid chambers 1250, 1254 are positioned such that the longitudinal extension of the first and the second fluid chambers 1250, 1254 extends in parallel and overlaps with the longitudinal extension of the drive unit 1210, at opposite sides thereof. The cross-section of the first and second fluid chambers 1250, 1254 may have any shape suitable for a fluid chamber and corresponding actuator piston, such as circular, square, oval, etc. Correspondingly, each of the first and second actuator piston may have any cross-sectional shape suitable for an actuator piston and corresponding fluid chamber for a hydraulic actuator for a spring preload adjustment system. Each of the first and second fluid chambers 1250, 1254 are arranged such as to contain and/or receive hydraulic fluid. The first end 1251, 1255 of each of the first and the second fluid chamber 1250, 1254, comprises an aperture 1257, 1258. The aperture 1257, 1258 is arranged to allow hydraulic fluid to exit and enter the respective first and second fluid chamber 1250, 1254.

The first and second actuator pistons 1240, 1244 are slidable inside the respective first and second fluid chamber 1250, 1254. Each of the first and second actuator piston 1240, 1244 is slidable in the second direction D2 for moving hydraulic fluid into the first and second fluid chamber 1250, 1254, via the aperture 1257, 1258, respectively. Each of the first and second actuator piston 1240, 1244 is also slidable in the first direction D1 for moving hydraulic fluid out of the first and second fluid chamber 1250, 1254, respectively, via the corresponding aperture 1257, 1258. The first and second actuator pistons 1240, 1244 may be any standard piston used for moving hydraulic fluid. The rack portion 1233 of the respective first and second actuator piston 1240, 1244 may be unitary or non-unitary to the respective first and second actuator piston 1240, 1244. As referred to herein, unitary generally means a single, uniform piece of material with no seams, joints, fasteners, or adhesives holding it together. That is, it is formed together simultaneously as a single continuous unit, e.g., by machining, moulding, forging, casting, printing, etc. As referred to herein, non-unitary components are generally formed separately and subsequently assembled, e.g., by welding.

The drive unit is operable to provide a rotational force in a first direction which, via the connecting portion 1214, rotates the lead screw 1220 in a first rotational direction around the axis 1216 of the drive unit 1210. The rotation of the lead screw 1220 in the first rotational direction around the axis 1216, induces a rotation of the first and second gear parts 1230, 1234, in a first rotational direction around their respective centre. The rotation of the first and second gear parts 1230, 1234 causes the first and second actuator pistons 1240, 1244 to move linearly within the respective first and second fluid chamber 1250, 1254 in the second direction D2 for moving hydraulic fluid into each of the first and second fluid chamber 1250, 1254, via the respective aperture 1257, 1258.

The drive unit is further operable to provide a rotational force in a second direction which, via the connecting portion 1214, rotates the lead screw 1220 in a second rotational direction around the axis 1216 of the drive unit 1210. The rotation of the lead screw 1220 in the second rotational direction around the axis 1216 induces a rotation of the first and second gear parts, 1230, 1234, in a second rotational direction around their respective centre. This rotation of the first and second gear parts 1230, 1234 causes the first and the second actuator pistons 1240, 1244 to move linearly within the respective first and second fluid chamber 1250, 1254 in the first direction D1 for moving hydraulic fluid out of each of the first and second fluid chambers 1250, 1254, via the respective aperture 1257, 1258. Thereby, each of the first and second actuator piston 1240, 1244 is operatively connected to the drive unit 1210.

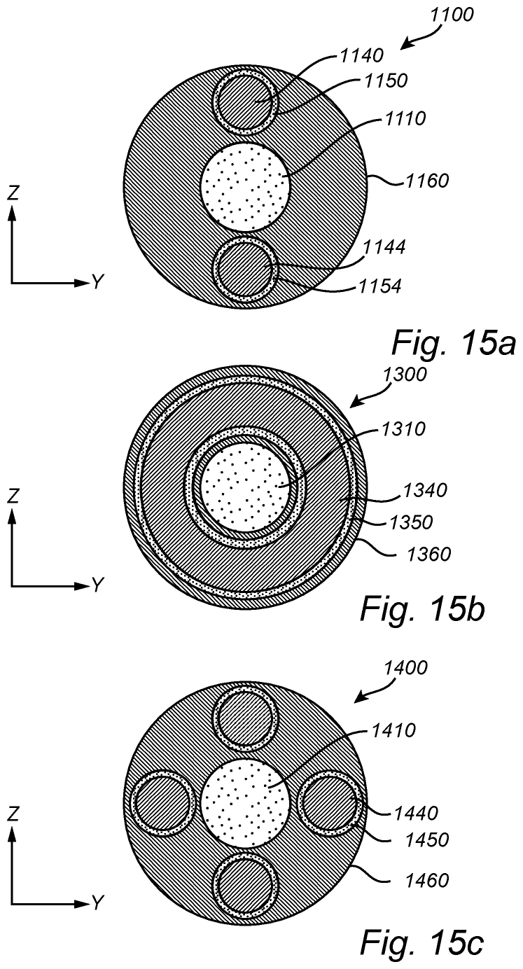

With reference to FIG. 15a, the embodiment of the hydraulic actuator 1100 described with reference to FIGS. 11 and 2 is shown in a sectional view taken along the line A-A of FIG. 10. As previously described, the hydraulic actuator 1100 comprises a drive unit 1110 a first and a second actuator piston 1140, 1144, a first and second fluid chamber 1150, 1154 and a housing 1160. The drive unit 1110 has a circular cross section and is surrounded, at opposite sides, by the first and the second fluid chamber 1150, 1154. The first and the second actuator pistons 1140, 1144 are positioned inside the first and the second fluid chamber 1150, 1154, respectively. The housing 1160 is arranged around the drive unit 1110, the first and the second actuator piston 1140, 1144 and the first and the second fluid chamber 1150, 1154 to provide a shell therefor. Although the shape of the cross-section of the housing 1160 is here illustrated as circular, the skilled person understands, in view of the present disclosure, that it is possible to provide the housing 1160 with a different shape.

With reference to FIG. 15b, another embodiment of a hydraulic actuator 1300 is shown in sectional view. In this exemplifying embodiment, the hydraulic actuator 1300 comprises a drive unit 1310, an actuator piston 1340, a fluid chamber 1350, and a housing 1360. The drive unit 1310 has a circular cross-section. The fluid chamber 1350 and the actuator piston 1340 are concentric with the drive unit 1310. The fluid chamber 1350 circumferentially extends around the drive unit 1310. The actuator piston 1340 is slidably arranged inside the fluid chamber 1350. The housing 1360 extends around the actuator piston 1340 and the fluid chamber 1350, providing a shell for the hydraulic actuator 1300. Although the shape of the cross-section of the housing 1360 is here illustrated as circular, the skilled person understands, in view of the present disclosure, that it is possible to provide the housing 1360 with a different shape.

With reference to FIG. 15c, yet another embodiment is shown in which a hydraulic actuator 1400 comprising four actuator pistons 1440 is shown in sectional view. In this exemplifying embodiment, the hydraulic actuator 1400 comprises a drive unit 1410, four actuator pistons 1440, four fluid chambers 1450 and a housing 1460. The drive unit 1410 has a circular cross-section. The four fluid chambers 1450 are positioned radially adjacent the drive unit 1410 with equal spacing around the drive unit 1410. The four actuator pistons 1440 are each slidably arranged inside a corresponding fluid chamber 1450. The housing 1460 extends around the actuator pistons 1440 and the fluid chambers 1450 to provide a shell for the hydraulic actuator 1400. Although the shape of the cross-section of the housing 1460 is here illustrated as circular, the skilled person understands, in view of the present disclosure, that it is possible to provide the housing 1460 with a different shape.

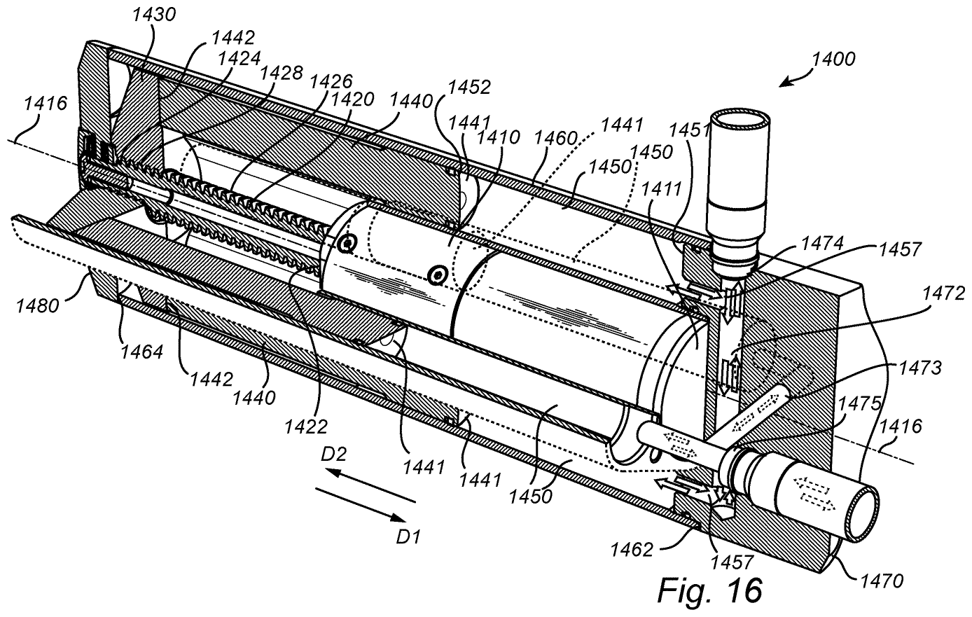

With reference to FIG. 16, the embodiment of the hydraulic actuator 1400 is shown in a perspective view which is partly cut-away. The hydraulic actuator 1400 comprises a drive unit 1410, a lead screw 1420 and a gear element 1430, here a lead screw nut 1430. The drive unit 1410 has a longitudinal extension along an axis 1416 of the drive unit 1410. The drive unit 1410 comprises a first end 1411 and a second end 1412, which is opposite the first end 1411. The drive unit 1410 is configured to provide a rotational force. As referred to herein, a second direction D2 is defined as the direction from the first end 1411 of the drive unit 1410 towards the second end 1412 of the drive unit 1410. As referred to herein, a first direction D1 is defined as opposite to the first direction. The drive unit 1410 is operable to, at its second end 1412, provide a rotational force, which is rotational around the axis 1416 of the drive unit 1410. The drive unit 1410 comprises a connecting portion (not shown) at its second end 1412. The connecting portion is rotatably connected to the lead screw 1420 at a first lead screw end 1422. The lead screw 1420 has a longitudinal extension along the axis 1416, from the first lead screw end 1422 to a second lead screw end 1424. Further, the lead screw 1420 comprises an external thread 1426, which spirally extends from the first lead screw end 1422 to the second lead screw end 1424. The longitudinal axis of the lead screw is aligned with the axis 1416 of the drive unit 1410. The lead screw is, via the external thread 1426, in a threaded connection 1428 with the gear element 1430. The gear element 1430 extends circumferentially around the lead screw 1420 with respect to the axis 1416.

The exemplified embodiment differs from the embodiment of hydraulic actuator 100 described with reference to FIG. 10 in that it comprises four actuator pistons 1440. Each of the four actuator pistons 1440 is connected to the gear element 1430, at a second end 1442 thereof. Each of the four actuator pistons 1440 extends longitudinally in parallel with the axis 1416, from the second end 1442, to a first end 1441 thereof. The second end 1442 of each of the four actuator pistons 1440, is connected to the gear element 1430, such that the longitudinal extension of each of the four actuator pistons 1440 extends in parallel with the longitudinal extension of the lead screw 1420. The four actuator pistons 1440 are radially adjacent the lead screw 1420 and/or the drive unit 1410 with equal spacing therearound, i.e., evenly distributed circumferentially around the lead screw 1420 and/or the drive unit 1410.

Further, in this exemplifying embodiment, the hydraulic actuator 1400 comprises four fluid chambers 1450. The four fluid chambers 1450, are positioned such that each of the four actuator pistons 1440 are slidable inside a corresponding fluid chamber 1450. Each of the four fluid chambers 1450 extends longitudinally, in the first direction D1, in parallel with the axis 1416, from a second end 1452, to a first end 1451. The longitudinal extension of each of the four fluid chambers 1450 extends in parallel with the longitudinal extension of the drive unit 1410. More particularly, the fluid chambers 1450 are radially adjacent the drive unit 1410 and equally distributed therearound. Further, the longitudinal extension of each of the four fluid chambers 1450 overlaps with the longitudinal extension of the drive unit 1410. The cross section of each of the four fluid chambers 1450 may be circular. The fluid chambers 1450 may be arranged to contain and/or receive hydraulic fluid. The first end 1451 of each of the four fluid chambers 1450 comprises an aperture 1457. The aperture 1457 is arranged to allow hydraulic fluid to exit and enter the corresponding fluid chamber 1450.

The hydraulic actuator 1400 comprises a housing 1460 for housing the drive unit 1410, the four actuator pistons 1440 and the four fluid chambers 1450. The housing 1460 has a longitudinal extension along the axis 1416, in the second direction D2, from a first housing end 1462 to a second housing end 1464. The hydraulic actuator 1400 comprises a first end cap 1470 connected to the housing 1460 at the first housing end 1462, and a second end cap 1480 connected to the housing at the second housing end 1464. The first and the second end caps 1470, 1480 seal the housing 1460 at opposite ends thereof and may thereby ensure that the components housed by the housing 1460 are secured therein.

In this exemplifying embodiment, the first end cap 1470 comprises a first and a second compartment 1472, 1473. The first compartment 1472 is, via a first pair of the four apertures 1457 connected to a first pair of the four fluid chambers 1450, wherein the first pair of the four fluid chambers 1450 are positioned at opposite sides of the drive unit 1410. The second compartment 1473 is, via a second pair of the four apertures 1457 connected to a second pair of the four fluid chambers 1450, wherein the second pair of the four fluid chambers 1450 are positioned at opposite sides of the drive unit 1410. Each of the first and second compartments 1472, 1473 further comprises a corresponding first or a second channel 1474, 1475. Each of the first and second channels 1474, 1475 extends from the corresponding first or second compartment 1472, 1473 through a wall portion of the first end cap 1470 to an exterior surface thereof. The first pair of the four fluid chambers are coupled to a first pair of the four actuator pistons 1440. The second pair of the four fluid chambers 1450 are coupled to a second pair of the four actuator pistons 1440. The first and the second pair of the four actuator pistons 1440 are positioned in connection with the gear element 1430 such to independently provide balance to the gear element 1430. The first and second channel 1474, 1475 are in the shown embodiment not interconnected and may further be coupled to different systems on a vehicle. For example, the first channel may be coupled to a front shock absorber system of a vehicle whereas the second channel may be couple to a rear shock absorber system of the vehicle. The hydraulic actuator 1400 may thereby, by one single motion of the gear element 1430, displace hydraulic fluid in first and second pairs of the four fluid chambers and thereby provide force output within two different system. In an alternative embodiment, the first and second compartments 1472, 1473 are interconnected. In yet an alternative embodiment, the end cap 1410 comprises only one compartment which is connected to the aperture 1457 of each of the four fluid chambers 1450.

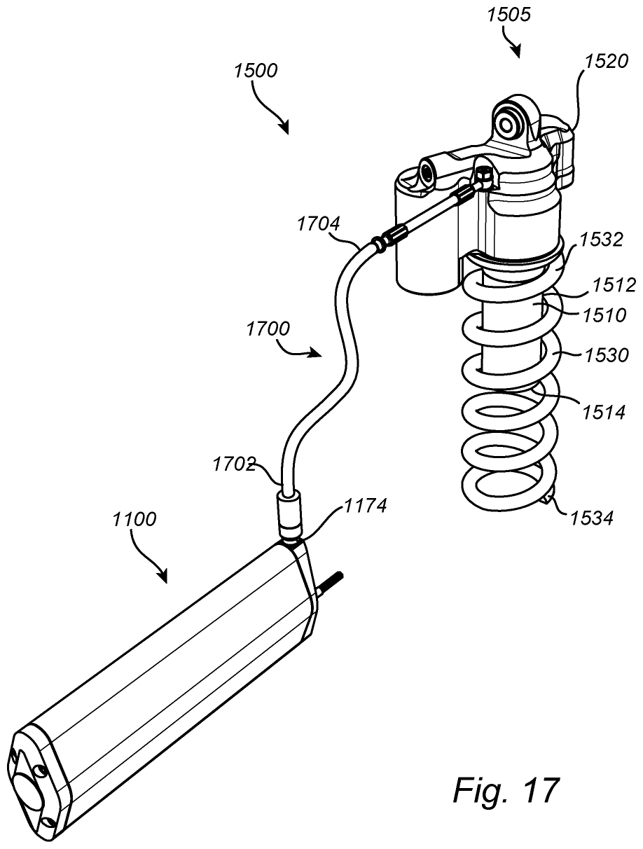

With reference to FIG. 17, a system 1500 for spring preload adjustment of a shock absorber according to an embodiment of the present disclosure is shown. The system 1500 comprises a hydraulic actuator as disclosed herein. In this exemplifying embodiment, the system comprises the hydraulic actuator 100 described with reference to FIG. 10. The system further comprises a preload adjuster 1600 comprising an adjuster piston 1620, both shown and described in more detail with reference to FIGS. 17a-b, and a connector 1700 arranged to provide a fluid connection between the hydraulic actuator 100 and the preload adjuster 1600. According to this embodiment, the system 1500 further comprises a cylinder head 1520 for a shock absorber 1505, which at least partly houses the preload adjuster 1600. For clarification, FIGS. 16, 17a, and 17b only show parts of the shock absorber 1505 that are necessary to elucidate the disclosure. Other parts have been omitted.

The connector 1700 extends from a first end 1702 to a second end 1704. The first end 1702 is connected to the channel 174 of the hydraulic actuator 100, such that, in operation of the system 1500, hydraulic fluid exiting the hydraulic actuator 100 via the channel 174 enters the connector 1700. Correspondingly, hydraulic fluid from the connector 1700 may enter the hydraulic actuator 100 via the channel 174 (best shown in FIG. 10). The second end 1704 of the connector 1700 is connected to the cylinder head 1520. The cylinder head 1520 is here arranged such to form an end portion of the shock absorber 1505.

The shock absorber 1505 comprises a shock absorber cylinder 1510, the cylinder head 1520 and a spring 1530. The shock absorber cylinder 1510 has a longitudinal extension from a first shock absorber cylinder end 1512 to a second shock absorber cylinder end 1514. An axial direction of the shock absorber 1505 is defined as the longitudinal extension of the shock absorber cylinder 1510. The shock absorber cylinder 1510 has a circular cross section. The cylinder head 1520 is arranged at the first shock absorber cylinder end 1512 such to provide an end portion of the shock absorber 1505.

The spring 1530 has a helical extension around the shock absorber cylinder 1510 from a first spring end 1532 to a second spring end 1534. The first spring end 1532 is closer to the first end 1512 of the shock absorber cylinder 1510 than the second spring end 1534. The spring 1530 is arranged around the shock absorber cylinder 1510 and extends beyond the second end 1514 thereof, at least in an extended state of the spring 1530, as shown.

With reference now to FIGS. 16a and 16b, a detail of the system 1500 described with reference to FIG. 17 is shown in cross-section in a non-preloading and a full preloading state of the preload adjuster 1600, respectively. More particularly, it is shown that the cylinder head 1520 houses the preload adjuster 1600. The cylinder head 1520 is here arranged at the shock absorber 1505 further comprising the shock absorber cylinder 1510 and the spring 1530. The cylinder head 1520 comprises a head portion 1522 which in this embodiment extends from the first shock absorber cylinder end 1512 in a direction away from the second shock absorber cylinder end 1514, when mounted thereat.

Further, the cylinder head 1520 comprises a cylindrical portion 1524 which, when mounted at the shock absorber 1505, extends from the first shock absorber cylinder end 1512 in a direction towards the second shock absorber cylinder end 1514. The cylindrical portion 1524 extends circumferentially around a portion of the longitudinal extension of the shock absorber cylinder 1510 when mounted. The cylindrical portion 1524 comprises an elongated inner recess 1526 extending around the inner perimeter of the cylindrical portion 1524 such that, when mounted at the shock absorber cylinder 1510, a circumferential space is created between the shock absorber cylinder 1510 and the cylindrical portion 1524. Alternatively, the cylindrical portion 1524 of the cylinder head 1520 may comprise a separate part or portion which extends in parallel with the recess 1526, radially inwards thereof, such to define a circumferential space between the outer wall of the recess 1526 of the cylindrical portion 1524 and the separate part or portion. For example, the cylinder head 1520 can be mounted on a tube for this specific purpose, i.e. to create a circumferential space between the outer wall of the recess 1526 and the tube. In another embodiment, the cylinder head 1520 comprises a tongue portion that extends from a point radially inwards of the recess 1526 and in parallel therewith to create a circumferential space between the outer wall of the recess 1526 and the tongue portion.

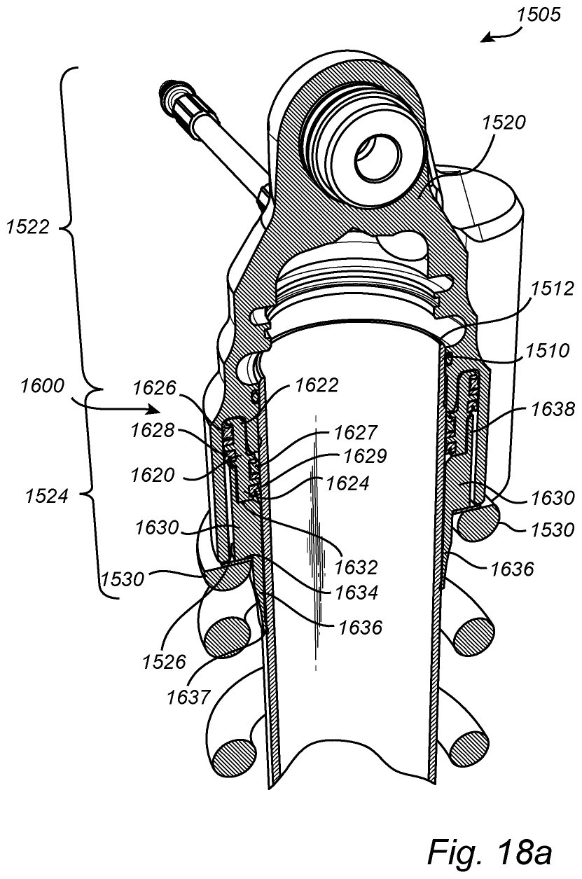

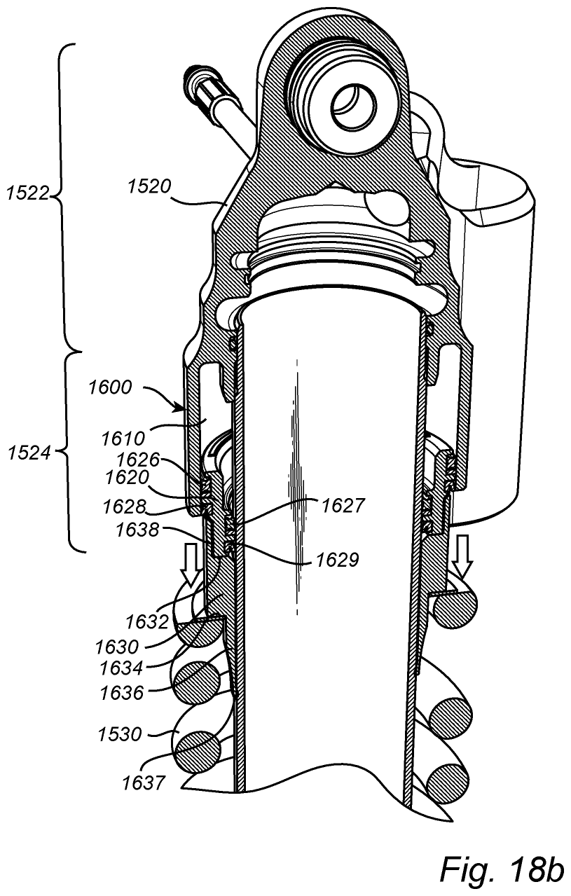

The preload adjuster 1600, comprises a preload chamber 1610, an adjuster piston 1620, a first and a second sealing ring 1626, 1627, a first and a second scraper ring 1628, 1629, and a spring guide 1630. The preload adjuster 1600 is in this exemplifying embodiment housed by the cylinder head 1520, and, more particularly positioned to be integrated in the cylindrical portion 1524. The preload chamber 1610, best seen in FIG. 18b, is positioned inside the inner recess 1526 and is here delimited by the recess walls, the shock absorber cylinder 1510 the adjuster piston 1620, and the first and second sealing rings 1626, 1627. Alternatively, in an embodiment comprising a separate part or portion defining a circumferential space between the outer wall of the recess 1526 and the separate part or portion, as described above, the preload chamber is delimited by the respective part or portion together with the recess walls and the adjuster piston 1620 with first and second sealing rings.

The adjuster piston 1620 is also arranged in the recess and extends circumferentially around the shock absorber cylinder 1510 such that it is closer to the second end 1514 of the shock absorber cylinder 1510 than the preload chamber 1610 when mounted therearound. The adjuster piston 1620 comprises a first adjuster piston portion 1622 and a second adjuster piston portion 1624, opposite the first adjuster piston portion 1622. The first adjuster piston portion 1622 of the adjuster piston 1620 is defining an outer boundary of the preload chamber 1610. The first sealing ring 1626 extends around the adjuster piston 1620 at the first adjuster piston portion 1622 at a radial outer surface thereof. The first sealing ring 1626 is arranged such that it seals the preload chamber 1610 by sealing a space between the adjuster piston 1620 and the cylinder head 1520. The second sealing ring 1627 extends around the adjuster piston 1620 at the second adjuster piston portion 1624 at a radial inner surface thereof. The second sealing ring 1627 seals the preload chamber 1610 by sealing a space between the adjuster piston 1620 and the shock absorber cylinder 1510. The first scraper ring 1628 extends around the adjuster piston 1620 at the first adjuster piston portion 1622 at a radial outer surface thereof and is arranged to be closer to the second adjuster piston portion 1624 than the first sealing ring 1626. By being connected at one end to the adjuster piston 1620 and at a second end scraping against the cylinder head 1520, the first scraper ring 1628 is preventing dirt and other damaging objects from entering inside the preload adjuster 1600 which could cause wear or damage. The second scraper ring 1629 extends around the adjuster piston 1620 at the second adjuster piston portion 1624 at a radial inner surface thereof and is arranged to be further away from the first adjuster piston portion 1622 than the second sealing ring 1627. The second scraper ring 1628 is, by being connected at one end to the adjuster piston 1620 and at a second end scraping against the shock absorber cylinder 1510 preventing dirt and other damaging objects from reaching the second sealing ring 1627 where it may cause wear or damage. Although it is advantageous to provide first and second sealing rings and first and second scraper rings as previously described, it is also possible within the concept of the present disclosure to provide, e.g., only the first and second sealing rings and no scraper rings, or combined seal and scraper portions at the adjuster piston.

The spring guide 1630 is arranged at the inner recess 1526, unless the preload adjuster 1600 is in its full preloading state, as shown in FIG. 18b, when it is positioned outside thereof. The spring guide 1630 comprises a piston abutting portion 1632 and a spring abutting portion 1634. The piston abutting portion is in direct contact with the adjuster piston 1620 and the spring abutting portion abuts the spring 1530 when the cylinder head 1520 is mounted at the shock absorber cylinder 1510. Here, the spring guide 1630 extends circumferentially around the shock absorber cylinder 1510. The spring guide 1630 further comprises a stabilizer portion 1636, which stabilizer portion 1636 projects from the spring abutting portion 1634 at an inner radial end thereof in a direction away from adjuster piston abutting portion 1632. The stabilizer portion 1636, further comprises a lip portion 1637, which lip portion 1637 abuts the shock absorber cylinder 1510 and extends circumferentially at an end of the stabilizing portion 1636 which is opposite the spring abutting portion 1634. The lip portion 1637 has a slight curvature towards the shock absorber cylinder 1510, thus sealing the space in between the stabilizing portion 1636 and the shock absorber cylinder 1510. The extension of the stabilizer portion 1636 is sufficiently long to ensure that the second sealing ring 1628, when the preload adjuster 1600 is in its full preloading state (see FIG. 18b), will not surpass the position of the lip portion 1637 when the preload adjuster 1600 is in its non-preloading state (see FIG. 18a). Thus, the lip portion 1637 prevents the second sealing ring 1628 from moving over a surface of the shock absorber cylinder 1510 which is neither concealed nor protected by the spring guide 1630. Thereby dirt or other damaging objects are prevented from entering the preload adjuster 1600. Further, said surface of the shock absorber cylinder 1510 is protected from being damaged, ensuring that the second sealing ring 1627 moves over a smooth continuous surface ensuring that the second sealing ring 1627 is able to prevent hydraulic fluid from exiting the preload chamber 1610. The spring guide may preferably be made of a polymer.

The spring guide 1630 further comprises a protective portion 1638, which protective portion projects from the piston abutting portion 1632, at an outer radial end portion thereof, and extends in parallel with an exterior lateral surface of the adjuster piston 1620, such to protect the adjuster piston 1620 from dirt or other damaging objects.

FIG. 18a shows the preload adjuster 1600 in a non-preloading state. This state is obtained when the hydraulic actuator 100 is operated to move the actuator piston in the second direction D2, whereby hydraulic fluid is pushed into the fluid chambers of the hydraulic actuator 100 from the preload chamber 1610 through the connector 1700 and thereby decreases hydraulic pressure in the preload adjuster 1600, thereby decreasing preload of the spring 1530. FIG. 17b shows the preload adjuster 1600 in a preloading state. This state is obtained when the hydraulic actuator 100 is operated to move the actuator piston in the first direction D1, whereby hydraulic fluid is pushed out of the fluid chambers of the hydraulic actuator 100 to the preload chamber 1610 through the connector 1700. The increase of hydraulic fluid in the preload chamber 1610 displaces the adjuster piston 1620 in the axial direction of the shock absorber, thus compressing the spring 1530. The compression of the spring 1530 is further increasing the internal pressure in the hydraulic system. The adjuster piston 1620 is thereby pushed in a direction parallel with the axial direction of the shock absorber 1500 towards the second shock absorber cylinder end 1514. When the adjuster piston 1620 moves in this direction, it pushes the spring guide 1630 which in turn compresses the spring 1530, thereby preloading it.

In the drawings and specification, there have been disclosed preferred embodiments and examples of the disclosure and, although specific terms are employed, they are used in a generic and descriptive sense only and not for the purpose of limitation, the scope of the invention being set forth in the following claims.

### Itemized List of Embodiments

1. A hydraulic actuator for a spring preload adjustment system for a shock absorber, the hydraulic actuator comprising
a drive unit arranged to provide power transmission via an axis of the drive unit;
one or more fluid chambers, each comprising an aperture at a first end thereof; and
one or more actuator pistons, each slidable within a respective fluid chamber in a second direction thereof for moving hydraulic fluid into the fluid chamber via the aperture and in a first direction for moving hydraulic fluid out of the fluid chamber via the aperture,
wherein
each of the one or more actuator pistons is operatively connected to the drive unit such that the power transmission provided by the drive unit generates a translation of the one or more actuator pistons in a direction of the axis; and
each of the one or more fluid chambers extends at least partly in parallel with the drive unit.

2. The hydraulic actuator according to item 1, wherein the drive unit has a longitudinal extension along the axis, and each of the one or more fluid chambers has a longitudinal extension parallel to the longitudinal extension of the drive unit, and wherein the longitudinal extension of each of the one or more fluid chambers at least partly overlaps with the longitudinal extension of the drive unit.

3. The hydraulic actuator according to any one of the preceding items, further comprising a lead screw operatively connected to the drive unit and extending therefrom along the axis, such that when the drive unit is operated the lead screw is rotated, thereby transmitting power from the drive unit along the axis.

4. The hydraulic actuator according to item 3, further comprising a gear element in connection with the lead screw, wherein the gear element is engaged with the one or more actuator pistons, such that rotation of the lead screw generates a linear or a rotational motion of the gear element which, in turn, generates the translation of the one or more actuator pistons.

5. The hydraulic actuator according to item 4, wherein the lead screw extends from the drive unit in the second direction of the axis and comprises a first lead screw end operatively connected to the drive unit and a second, opposite lead screw end, wherein the gear element is arranged to move linearly towards the first lead screw end when the drive unit is actuated to move the one or more actuator pistons in the first direction for moving hydraulic fluid out of the one or more fluid chambers, and to move linearly towards the second lead screw end when the drive unit is actuated to move the one or more actuator pistons in the second direction for moving hydraulic fluid into the one or more fluid chambers.

6. The hydraulic actuator according to any one of the preceding items, comprising a housing for housing the drive unit, the one or more fluid chambers and the one or more actuator pistons, and first and second end caps.

7. The hydraulic actuator according to item 6 wherein the first end cap comprises a compartment in connection with the aperture of the each of the of the one or more fluid chambers, and wherein the end cap comprises a channel extending from the compartment through a wall portion of the end cap to an exterior surface thereof.

8. The hydraulic actuator according to item 6 comprising two or more actuator pistons and two or more fluid chambers, wherein the first end cap comprises two compartments, each in connection with an aperture of at least one of the two or more fluid chambers without the compartments being interconnected, and wherein each compartment is in connection with a channel extending through a wall portion of the end cap to an exterior surface thereof.

9. The hydraulic actuator according to any one of the preceding items, further comprising a pressure sensor configured to sense a pressure within at least one fluid chamber.

10. A method of actuating a hydraulic actuator for a spring preload adjustment system of a shock absorber, the method comprising
providing a hydraulic actuator according to any one of items 1-9;
actuating the drive unit of the hydraulic actuator to provide power transmission via an axis of the drive unit in a first rotational direction thereof, wherein the power transmission in the first rotational direction generates a translation of the one or more actuator pistons of the hydraulic actuator in a direction parallel with the axis in a second direction of the one or more fluid chambers of the hydraulic actuator for moving hydraulic fluid into the one or more fluid chambers, and/or
actuating the drive unit to provide power transmission via the axis in a second rotational direction thereof, generating thereby a translation of the one or more actuator pistons in a first direction of the one or more fluid chambers for moving hydraulic fluid out of the fluid chamber.

11. A system for spring preload adjustment of a shock absorber, the system comprising a hydraulic actuator according to any one of the preceding items 1-10, a preload adjuster comprising an adjuster piston, and a connector arranged to provide a fluid connection between the hydraulic actuator and the preload adjuster, wherein the adjuster piston is operable by the hydraulic actuator to move in an axial direction of a shock absorber cylinder onto which it is mounted, and arrangeable to act on a spring of the shock absorber such to affect the preload of the same.

12. The system according to item 11, further comprising a cylinder head for a shock absorber, wherein the cylinder head at least partly houses the preload adjuster.

1. A hydraulic actuator for a spring preload adjustment system for a shock absorber, the hydraulic actuator comprising:
a fluid chamber;
a piston slidably arranged within the fluid chamber in a first direction for moving hydraulic fluid out of the fluid chamber to increase spring preload of a shock absorber connected to the hydraulic actuator, and in a second, opposite, direction for allowing hydraulic fluid to enter the fluid chamber to decrease spring preload of the shock absorber; and
a drive assembly operatively engageable with the piston, comprising:
a drive unit;
a lead screw operatively connected to the drive unit; and
a gear element engaged with the lead screw and arrangeable to abut the piston,
wherein
the drive assembly is operable to actuate the piston to slide in the first direction and is operable to allow the piston to slide in the second direction without the drive unit being actuated.

2. The hydraulic actuator according to claim 1, wherein
the drive unit is arranged to provide power transmission via an axis thereof, and
the lead screw is operatively connected to the drive unit and extending therefrom along the axis, such that when the drive unit is operated, the lead screw is rotated around the axis, thereby transmitting power from the drive unit along the axis, and
the gear element is threadedly engaged with the lead screw such that rotation of the lead screw in a first rotational direction around the axis generates a linear motion of the gear element in the first direction and rotation of the lead screw in a second rotation direction around the axis generates a linear motion of the gear element in the second direction.

3. The hydraulic actuator according to claim 1 further comprising a valve arrangement operable between a closed mode for preventing flow of hydraulic fluid into the fluid chamber and an open mode for allowing flow of hydraulic fluid into the fluid chamber.

4. The hydraulic actuator according to claim 1, wherein the gear element is movable in the second direction relative to the piston.

5. The hydraulic actuator according to claim 3, wherein the valve arrangement comprises a solenoid valve.

6. The hydraulic actuator according to claim 3, further comprising a housing which houses the fluid chamber, the piston, and the drive assembly, wherein the valve arrangement is arranged external to the housing.

7. The hydraulic actuator according to claim 3, further comprising a housing which houses the fluid chamber, the piston, the drive assembly, and the valve arrangement.

8. The hydraulic actuator according to claim 3, wherein the valve arrangement comprises;
a valve body,
a valve member adapted to be movable relative to the valve body between a first position to control the valve arrangement to be in the closed mode and a second position to control the valve arrangement to be in the open mode, wherein the gear element is arrangeable to engage the valve member when moved in the second direction to a predetermined point for moving the valve member from the first position to the second position as the gear element is further moved in the second direction.

9. The hydraulic actuator according to claim 3, wherein the valve arrangement comprises a first valve for regulating a first fluid flow path for moving hydraulic fluid out of the fluid chamber to increase spring preload of the shock absorber and a second valve for regulating a second fluid flow path for moving hydraulic fluid into the fluid chamber to decrease spring preload of the shock absorber.

10. The hydraulic actuator according to claim 9, wherein the first valve is a check valve.

11. The hydraulic actuator (100) according to claim 9, wherein the second valve is controlled by the gear element.

12. The hydraulic actuator according to claim 9, wherein the second valve is a spool valve.

13. The hydraulic actuator according to claim 9, wherein the second valve comprises:
a valve body providing an inlet and an outlet; and
a valve member adapted to be movable relative to the valve body between a first position to fluidly disconnect the inlet and the outlet such that the second fluid flow path is closed and a second position to fluidly connect the inlet and the outlet such that the second fluid flow path is open, wherein
the valve member is pretensioned into the first position, and
the gear element is arrangeable to engage the valve member when moved in the second direction to a predetermined point for moving the valve member from the first position to the second position as the gear element is further moved in the second direction.

14. The hydraulic actuator according to claim 8, wherein the valve member is pretensioned into the first position by hydraulic pressure.

15. A hydraulic actuator according to claim 1, wherein the drive unit has a longitudinal extension along the axis and the fluid chamber has a longitudinal extension along or in parallel with the axis which longitudinal extension of the fluid chamber is at least partly overlapping with the longitudinal extension of the drive unit.

16. A system for spring preload adjustment of a shock absorber, the system comprising a hydraulic actuator according to claim 1, a preload adjuster comprising an adjuster piston, and a connector defining a fluid flow connection between the hydraulic actuator and the preload adjuster, wherein the adjuster piston is operable by the hydraulic actuator to move in an axial direction of a shock absorber cylinder onto which it is mounted, and arrangeable to act on a spring of the shock absorber such to affect the preload of the same.

17. A method for adjusting preload of a shock absorber, the method comprising:
Providing a hydraulic actuator (100) according to claim 1;
operatively disengaging the drive unit from the piston;
allowing hydraulic fluid into the fluid chamber such that the piston slides in the second direction for rapidly reducing preload of the shock absorber without the drive unit being actuated; and, optionally,
Actuating the piston in the first direction for increasing preload of the shock absorber.

18. The method according to claim 17, wherein the step of operatively disengaging the drive unit comprises:
preventing flow of hydraulic fluid into the fluid chamber;
moving the gear element relative to the piston in the second direction; and
allowing flow of hydraulic fluid to enter the fluid chamber.

19. The method according to claim 18, wherein moving the gear element comprises:
moving the gear element relative to the piston in the second direction into engagement with a valve member of the hydraulic actuator; and
moving the gear element relative to the piston in the second direction for moving the valve member into the second position for allowing flow of hydraulic fluid to enter the fluid chamber.
